(19) United States
(12) Patent Application Publication
(10) Pub. No.: US 2025/0286938 A1
(43) Pub. Date: Sep. 11, 2025

(54) SYSTEMS AND METHODS FOR REDUCING PACKET SIZE

(71) Applicant: Advanced Micro Devices, Inc., Santa Clara, CA (US)

(72) Inventors: Rajshekhar Biradar, Bangalore (IN); Sunil Kulkarni, Bangalore (IN)

(21) Appl. No.: 18/600,462

(22) Filed: Mar. 8, 2024

(51) Int. Cl. H04L 69/22

(52) U.S. Cl. CPC H04L 69/22

(57) ABSTRACT

Tunnel endpoints may encapsulate the packets of a network flow, such as a forward flow from one computer to another, in encapsulating packets. A forward flow packet of the forward flow may include static header fields, pseudo-dynamic header fields, and dynamic fields. The control plane and the data plane of a tunnel endpoint may omit the static header fields and may omit the pseudo-dynamic header fields from encapsulating packets after sending a first encapsulating packet that includes the forward flow packet and a forward flow value associated with the forward flow. Subsequent encapsulating packets may include the forward flow value and the dynamic field values of subsequent forward flow packets of the forward flow. The static header fields and/or the pseudo-dynamic header fields of the subsequent forward flow packets may be omitted from the subsequent encapsulating packet.

### TECHNICAL FIELD

The systems and methods relate to computer networks, servers, local area networks (LANs), networking devices, virtual LANs (VLANs), network tunnels, tunnel endpoints and packet encapsulation. The systems and methods also relate to reducing the size of encapsulating packets that encapsulate packets traversing a tunnel.

### BACKGROUND

A local area network (LAN) may be a network that connects computers within a limited geographical area. Network virtualization technologies such as virtual extensible local area network (VXLAN) and Generic Network Virtualization Encapsulation (GENEVE) may connect distinct LANs into a virtual local area network (VLAN). Such a VLAN may be called an overlay network. An overlay network may be a virtual network that overlays a physical network. Two distinct LANs may be connected into a VLAN by tunnel endpoints that connect the LANs by encapsulating the packets sent from one LAN to the other in encapsulating packets and sending the encapsulating packets to the other tunnel endpoint. The Internet engineering task force (IETF) specified the encapsulation protocols and formats for VXLAN in request for comment (RFC) 7348 published in August 2014. The IETF specified the encapsulation protocols and formats for GENEVE in RFC 8926 published in November 2020, 2012 and last updated in January 2021. GENEVE provides for protocol extensions. VXLAN did not originally consider protocol extension. In November 2023 the IETF published “Generic Protocol Extension for VXLAN (VXLAN-GPE)” which specifies the formats for shim headers that may be used for VXLAN protocol extensions. Systems and methods are needed for more efficiently utilizing the bandwidth in tunnels between tunnel endpoints.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure as a prelude to the more detailed description that is presented later.

An aspect of the subject matter described in this disclosure may be implemented by a system. The system may include a packet processing pipeline circuit configured to implement a data plane, and a processor configured to implement a control plane, wherein the control plane and the data plane are configured to send a first encapsulating packet that includes a forward flow packet of a forward flow and a forward flow value associated with the forward flow, the forward flow packet including a plurality of static header fields of the forward flow packet and a plurality of dynamic fields of the forward flow packet, and send a second encapsulating packet, the second encapsulating packet including the forward flow value and a plurality of dynamic fields of a second forward flow packet of the forward flow, wherein a plurality of static header fields of the second forward flow packet is omitted from the second encapsulating packet.

Another aspect of the subject matter described in this disclosure may be implemented by a system. The system may include a packet processing pipeline circuit configured to implement a data plane, and a processor configured to implement a control plane, wherein the control plane and the data plane are configured to omit a plurality of static header fields from a plurality of encapsulating packets by storing a plurality of static header field values of a forward flow packet corresponding to a forward flow value in response to receiving a first encapsulating packet that includes the forward flow value and the forward flow packet, and recovering a second forward flow packet by combining the plurality of static header field values stored corresponding to the forward flow value with a plurality of dynamic field values of the second forward flow packet in response to receiving a second encapsulating packet that includes the forward flow value and the plurality of dynamic field values of the second forward flow packet, wherein the plurality of static header fields of the second forward flow packet is omitted from the second encapsulating packet.

Yet another aspect of the subject matter described in this disclosure may be implemented as a method. The method may include receiving a first packet in a forward flow, the first packet including a plurality of static header field values in a plurality of static header fields, storing, in a flow table, a flow table entry for the forward flow corresponding to a forward flow value in response to receiving the first packet, the flow table entry for the forward flow including the plurality of static header field values, and sending a first encapsulating packet that includes the forward flow value and a plurality of dynamic field values of a forward flow packet in the forward flow in response to receiving the forward flow packet, the plurality of static header fields omitted from the first encapsulating packet.

In some implementations of the methods and devices, the plurality of static header fields includes a destination address field, a source address field, a destination port field, and a source port field. In some implementations of the methods and devices, the control plane and the data plane are configured to store a reverse flow value corresponding to a plurality of static header field values of the forward flow packet, receive a third encapsulating packet that includes the reverse flow value and a plurality of dynamic header field values of a reverse flow packet, and use the dynamic header field values of the reverse flow packet and the reverse flow value to recover the reverse flow packet, wherein the plurality of static header fields of the reverse flow packet is omitted from the third encapsulating packet. In some implementations of the methods and devices, recovering the reverse flow packet includes using the reverse flow value to obtain the plurality of static header field values from a flow table, and using the plurality of static header field values to assemble a header of the reverse flow packet in response to obtaining the plurality of static header field values from the flow table. In some implementations of the methods and systems, the systems may further include a memory configured to store a flow table that includes a flow table entry for the forward flow and that includes a flow table entry for a reverse flow that includes the reverse flow packet, wherein the data plane is configured to produce the reverse flow packet by using the reverse flow value that is in the third encapsulating packet to locate the flow table entry for the reverse flow and to read the plurality of static header field values of the reverse flow packet from the flow table entry for the reverse flow, and the data plane is configured to use forward flow value to locate the flow table entry for the forward flow in response to receiving a packet of the forward flow. In some implementations of the methods and devices, the control plane is configured to store the flow table entry for the forward flow and the flow table entry for the reverse flow in the flow table in response to receiving the forward flow packet. In some implementations of the methods and devices, the control plane is configured to use a plurality of networking rules to produce forward flow processing directives and to store the forward flow processing directives in the flow table entry for the forward flow, and use the plurality of networking rules to produce reverse flow processing directives and to store the reverse flow processing directives in the flow table entry for the reverse flow. In some implementations of the methods and devices, hashing a 5-tuple of the reverse flow packet produces the reverse flow value. In some implementations of the methods and devices, the plurality of static header field values of the forward flow packet includes a forward flow destination address value, a forward flow source address value, a forward flow destination port value, and a forward flow source port value, and the plurality of static header field values of the reverse flow packet includes a reverse flow destination address value that equals the forward flow source address value, a reverse flow source address value that equals the forward flow destination address value, a reverse flow destination port value that equals the forward flow source port value, and a reverse flow source port value that equals the forward flow destination port value.

In some implementations of the methods and devices, hashing a 5-tuple of the forward flow packet produces the forward flow value. In some implementations of the methods and systems, the systems may further include a networking device configured to store a plurality of static header field values of the forward flow packet corresponding to the forward flow value in response to receiving the first encapsulating packet, use the forward flow value in the second encapsulated packet to obtain the plurality of static header field values of the forward flow packet in response to receiving the second encapsulating packet, and recover the second forward flow packet by combining the plurality of static header field values obtained using the forward flow value with the dynamic fields of the second forward flow packet that are in the second encapsulating packet. In some implementations of the methods and devices, the first encapsulating packet includes a shim header that includes the forward flow value. In some implementations of the methods and devices, the first encapsulating packet is a virtual extensible local area network (VXLAN) packet. In some implementations of the methods and devices, the first encapsulating packet is a GENEVE packet. In some implementations of the methods and devices, omitting the plurality of static header fields from encapsulating packets includes storing, in a flow table, a first value corresponding to a plurality of static header field values of a first packet in response to receiving a third encapsulating packet that includes the first value and the first packet, receiving a fourth encapsulating packet that includes the first value and a plurality of dynamic field values of a second packet, using the first value in the fourth encapsulated packet to obtain the plurality of static header field values of the first packet from the flow table, and recovering the second packet by combining the plurality of static header field values obtained using the first value with the plurality of dynamic field values of the second packet included in the fourth encapsulating packet.

In some implementations of the methods and systems, omitting the plurality of static header fields from the plurality of encapsulating packets may include storing a flow table entry for a reverse flow corresponding to a reverse flow value in response to receiving the first encapsulating packet, calculating a flow table key for a reverse flow packet that is in the reverse flow in response to receiving the reverse flow packet, the flow table key equaling the reverse flow value, determining that the reverse flow omits the plurality of static header fields by using the flow table key to access the flow table entry for the reverse flow, and producing a third encapsulating packet that includes the reverse flow value and a plurality of dynamic fields of the reverse flow packet in response to determining that the reverse flow omits the plurality of static header fields, wherein the third encapsulating packet omits the plurality of static header fields. In some implementations of the methods and systems, the systems may further include a memory configured to store a flow table that includes a flow table entry for a forward flow that includes the forward flow packet and that includes the flow table entry for the reverse flow, wherein the data plane is configured to recover the second forward flow packet by using the forward flow value that is in the second encapsulating packet to locate the flow table entry for the forward flow and to read the plurality of static header field values of the forward flow packet from the flow table entry for the forward flow, and the data plane is configured to use the reverse flow value to locate the flow table entry for the reverse flow in response to receiving a packet of the reverse flow.

In some implementations of the methods and systems, the methods may further include storing, in the flow table, a flow table entry for a reverse flow corresponding to a reverse flow value in response to receiving the first packet, the flow table entry for the reverse flow including the plurality of static header field values, using a flow table key to obtain the plurality of static header fields values in response to receiving a second encapsulated packet that includes the flow table key and a plurality of dynamic field values of a reverse flow packet, the flow table key equaling the reverse flow value, and recovering the reverse flow packet by combining the plurality of static header field values obtained using the flow table key with the plurality of dynamic field values of the reverse flow packet included in the second encapsulating packet.

These and other aspects will become more fully understood upon a review of the detailed description, which follows. Other aspects and features will become apparent to those of ordinary skill in the art, upon reviewing the following description of specific examples in conjunction with the accompanying figures. While features may be discussed relative to certain examples and figures below, any example may include one or more of the advantageous features discussed herein. In other words, while one or more examples may be discussed as having certain advantageous features, one or more of such features may also be used in accordance with the various examples discussed herein. In similar fashion, while the examples may be discussed below as devices, systems, or methods, the examples may be implemented in various devices, systems, and methods.

### BRIEF DESCRIPTION OF THE DRAWINGS

FIG. 1A is a high level conceptual diagram illustrating an example of tunnel endpoints using shim headers and an abbreviated packet to conserve network bandwidth in a forward flow, according to some aspects.

FIG. 1B is a high level conceptual diagram illustrating an example of tunnel endpoints using shim headers and an abbreviated packet to conserve network bandwidth in a reverse flow, according to some aspects.

FIG. 2 is a high level functional block diagram illustrating an example of a networking device having a control plane and a data plane and in which aspects may be implemented.

FIG. 3 is a high level functional block diagram illustrating an example of a match-action unit in a match-action pipeline according to some aspects.

FIG. 4 is a functional block diagram of a networking device having a semiconductor chip such as an application specific integrated circuit (ASIC) or field programmable gate array (FPGA), according to some aspects.

FIG. 5 is a high level conceptual diagram illustrating an example of generating a packet header vector from a packet according to some aspects.

FIG. 6 is a high level block diagram illustrating an example of a match processing unit (MPU) that may be used within the exemplary system of FIG. 4 to implement some aspects.

FIG. 7 is a high level block diagram illustrating an example of a packet processing pipeline circuit that may be included in the exemplary system of FIG. 4.

FIG. 8 is a high level conceptual diagram illustrating an example of packet headers and payloads of packets for network traffic flows, according to some aspects.

FIG. 9 is a high level conceptual diagram illustrating an example of producing a forward flow table entry, a reverse flow table entry, and a session table entry, according to some aspects.

FIG. 10 is a high level conceptual diagram illustrating an example of a control plane producing a forward flow table entry, a reverse flow table entry, and a session table entry, according to some aspects.

FIG. 11 is a high level conceptual diagram illustrating an example of an encapsulating packet that includes the static header fields and bandwidth saving aspect (BSA) metadata, according to some aspects.

FIG. 12 is a high level conceptual diagram illustrating an example of a VXLAN-GPE encapsulating packet that omits the static header fields and has BSA metadata, according to some aspects.

FIG. 13 is a high level conceptual diagram illustrating an example of an GENEVE encapsulating packet that omits the static header fields and has BSA metadata, according to some aspects.

FIG. 14 is a high level flow diagram illustrating an example of a process for handling a flow miss, according to some aspects.

FIG. 15 is a high level flow diagram illustrating an example of a process for handling packets for BSA enabled flows, according to some aspects.

FIG. 16 is a high level flow diagram illustrating an example of a method for using abbreviated packets that omit header fields, according to some aspects.

Throughout the description, similar reference numbers may be used to identify similar elements.

### DETAILED DESCRIPTION

It will be readily understood that the components of the examples as generally described herein and illustrated in the appended figures could be arranged and designed in a wide variety of different configurations. Thus, the following more detailed description of various examples, as represented in the figures, is not intended to limit the scope of the present disclosure, but is merely representative of various examples. While the various aspects of the examples are presented in drawings, the drawings are not necessarily drawn to scale unless specifically indicated.

Systems and methods that implement aspects may have various differing forms. The described systems and methods are to be considered in all respects only as illustrative and not restrictive. The scope of the claims is, therefore, indicated by the claims themselves rather than by this detailed description. All changes which come within the meaning and range of equivalency of the claims are to be embraced within their scope.

Reference throughout this specification to features, advantages, or similar language does not imply that any system or method implements each and every aspect that may be realized. Rather, language referring to the features and advantages is understood to mean that a specific feature, advantage, or characteristic described in an example may be implemented in or by at least one example. Thus, discussions of the features and advantages, and similar language, throughout this specification may, but do not necessarily, refer to the same example.

Furthermore, the described features, advantages, characteristics, and aspects may be combined in any suitable manner in one or more systems or methods. One skilled in the relevant art will recognize, in light of the description herein, that one example may be practiced without one or more of the specific features or advantages of another example. In other instances, additional features and advantages may be recognized in one example that may not be present in all the examples.

Reference throughout this specification to “one example”, “an example”, or similar language means that a particular feature, structure, or characteristic described in connection with the indicated example may be included in at least one example. Thus, the phrases “in one example”, “in an example”, and similar language throughout this specification may, but do not necessarily, all refer to the same example.

Overlay networks are often employed for managing the connectivity and the security of the many thousands of servers in a data center. An overlay network may be a virtual network that may be implemented within a physical network using encapsulation technologies, such as VXLAN or GENEVE, to tunnel packets between tunnel endpoints that connect LANs or other distinct parts of a physical network. The packets traversing the tunnel may have small payloads. For example, a keep-alive packet may have a payload of just a few bytes. The headers of such packets may be much larger than the payloads. As such, the packet headers may consume most of the bandwidth used by a tunnel.

The packet headers of packets in flows or sessions may be reduced in size by omitting static header fields and including a value that may be used to recover the header field values in the static header fields. A flow may be the packets that a first computer may send to a second computer. A session between the computers may include a forward flow that includes forward flow packets going from the first computer to the second computer and a reverse flow that includes reverse flow packets going from the second computer to the first computer. Many of the header fields in the forward flow packets and the reverse flow packets are static fields that do not change during the session or flows. For example, all the forward flow packets may have the same source media access control (MAC) address, destination MAC address, source internet protocol (IP) address, destination IP address, etc. Furthermore, the header field values in reverse flow packets often mirror the header field values in forward flow packets (e.g., reverse flow source IP address equals forward flow destination IP address).

Aspects of encapsulation protocols may be leveraged to replace some of or all of the static header fields of encapsulated packets with shim headers that are smaller. For example, a forward flow packet may be an ethernet packet carrying an IP packet that is carrying a transmission control protocol (TCP) packet. The static header fields that may be removed may include the ethernet header, IPv4 static header fields (e.g., source IP address, destination IP address, protocol, etc.), and TCP static header fields (e.g., source port, destination port). The static header fields of the forward flow packet may be replaced by an 8 byte VXLAN-GPE shim header, by options data in a GENEVE header (e.g., 4 bytes of options data), etc. For conciseness, the VXLAN-GPE shim header, the GENEVE options data, and similar aspects of other encapsulation protocols are herein simply called shim headers.

Bandwidth savings of over 80% have been realized by replacing the static header fields of encapsulated packets with shim headers. Bandwidth reductions may save costs, relieve network congestion, and improve network performance. Furthermore, network security may be increased because the 3 byte value may obfuscate the source, destination, and protocol of the encapsulated packet.

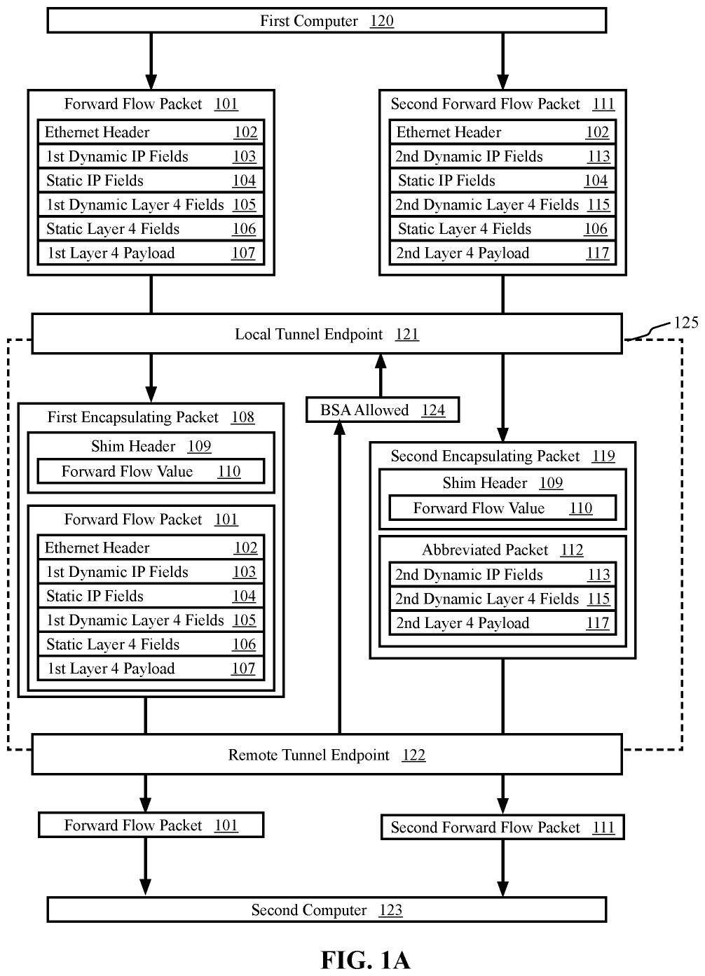

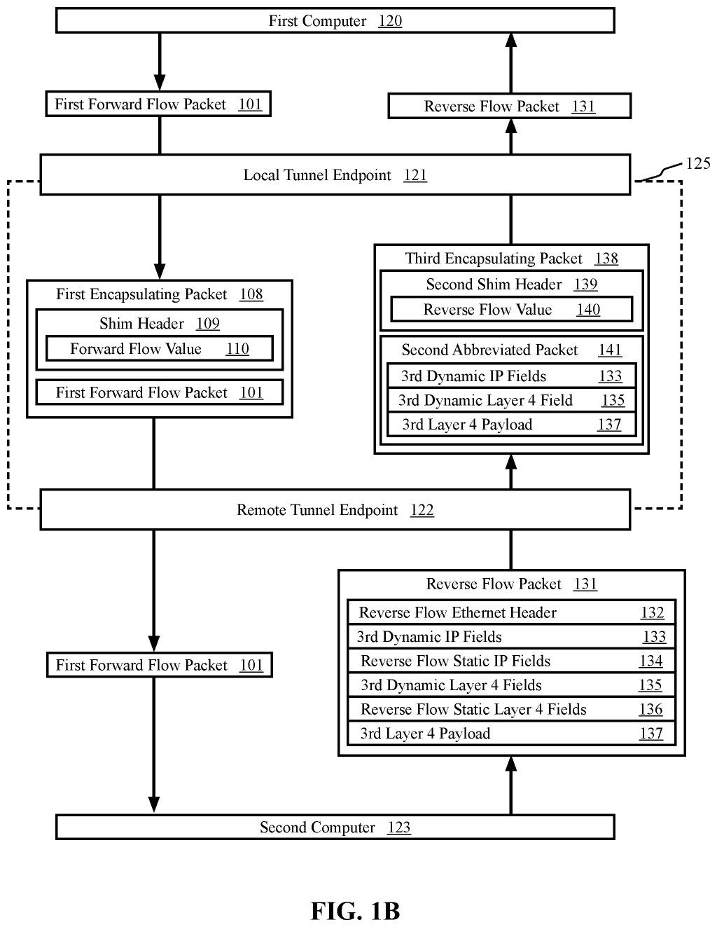

FIG. 1A is a high level conceptual diagram illustrating an example of tunnel endpoints using shim headers and an abbreviated packet to conserve network bandwidth in a forward flow, according to some aspects. The communications between a first computer 120 and a second computer 123 may go through a tunnel 125 formed by a local tunnel endpoint 121 and a remote tunnel endpoint 122. The communications between the computers may be carried by packets in packet flows. In computer networking, a packet flow may be a sequence of packets that share common attributes. For example, the common attributes uniquely identifying a TCP or user datagram protocol (UDP) flow may be the packet 5-tuple (source and destination IP, source and destination port and the protocol field). A tunnel endpoint may tunnel the communications by encapsulating the packets of the flows in encapsulating packets and sending the encapsulating packets to the other tunnel endpoint. The tunnel may include numerous physical networks and networking devices that may be carrying large volumes of networking traffic and may be charging fees for doing so. It may be beneficial to reduce the bandwidth consumed by the tunnel.

The first computer 120 may send a forward flow packet 101 to the second computer 123. The network flows in sessions are often called forward flows and reverse flows. The forward flow consists of the packets from the first computer 120 that go to the second computer 123. The reverse flow consists of the packets from the second computer 123 that go to the first computer 120. The forward flow packet 101 may have a layer 2 header, a layer 3 header, a layer 4 header, and a layer 4 payload. The headers include static fields and dynamic fields. The static header fields are the header fields remaining constant for the life of a flow. The dynamic fields include the payload and the header fields that may change during the flow. The layer 2 header may be an ethernet header 102 that is a static header field. The layer 3 header may be an IP packet header that has first dynamic IP fields 103 and static IP fields 104. The layer 4 header may be a TCP header, a UDP header, or some other layer 4 header that has static layer 4 fields 106 and first dynamic layer 4 fields 105. The forward flow packet 101 may have a first layer 4 payload 107 that may be a dynamic field. The forward flow packet 101 travels to the second computer 123 via a tunnel 125 formed by a local tunnel endpoint 121 and a remote tunnel endpoint 122.

The local tunnel endpoint 121 may receive the forward flow packet 101 from the first computer and may encapsulate the forward flow packet 101 in a first encapsulating packet 108. The local tunnel endpoint may add bandwidth saving aspect (BSA) metadata to the first encapsulating packet 108 if the first forward packet is bandwidth saving aspect (BSA) eligible. A packet may be BSA eligible if a forward flow value 110 calculated from the packet's header field values is unique. For example, a TCP/IP or UDP/IP packet may have a packet 5-tuple that includes the source IP address, destination IP address, protocol identifier, source port number, and destination port number. The packet 5-tuple remains constant during the life of a network flow because all the packets in the flow have that same 5-tuple. As such, the flow may be considered to have that 5-tuple because that 5-tuple may be used to identify every packet in the flow. A flow value calculated from the 5-tuple may therefore be used to identify the flow if the flow value is unique. Hash calculators may be used for calculating flow values from 5-tuples. For example, a Cyclic Redundancy Check 32 (CRC-32) hash calculator, as is well known in the art, may calculate a 32 bit value from a packet 5-tuple and 20 of those 32 bits may be used as a flow value for the flow having that 5-tuple. A flow table may be used to store flow table entries for all the flows that a networking device, such as a tunnel endpoint, may be configured to process. The flow value calculated from a packet's 5-tuple may be used to locate or access the flow table entry for the flow that includes that packet. A flow may be BSA eligible when the flow value for the flow is unique. In other words, if the tunnel endpoint is already configured to process a different flow that has the same flow value, then the flow may be not BSA eligible. Note that IP version 4 (IPv4) has a “protocol” field that holds a protocol identifier whereas IP version 6 (IPv6) has a “next header” field that is substantially the same and that is often referred to as the protocol field. For the purposes of this disclosure, the IPv4 protocol field and the IPv6 next header field may be treated as the same field.

The first encapsulating packet 108 is shown encapsulating the forward flow packet 101. The local tunnel endpoint 121 may use a shim header 109 to add the BSA metadata for the forward flow to the first encapsulating packet 108. For example, the shim header 109 may include a forward flow value 110 calculated from the 5-tuple of the forward flow packet. The local tunnel endpoint 121 may send the first encapsulating packet 108 to the remote tunnel endpoint 122. Note that the terms “local” and “remote” do not indicate geographic separation of the tunnel endpoints but are the terms those practiced in the art often use to distinguish one tunnel endpoint from the other. The remote tunnel endpoint 122 may receive the first encapsulating packet 108, may decapsulate the forward flow packet 101, and may send the forward flow packet to the second computer. Furthermore, the remote tunnel endpoint may use the BSA metadata to prepare for and enable BSA for the forward flow and for the reverse flow. For example, the remote tunnel endpoint may consult its own flow table to determine that the forward flow may be BSA eligible. Here, again, a flow may not be BSA eligible if the remote tunnel endpoint 122 is already configured to process a different flow having a flow value equaling the forward flow value. If the forward flow is BSA eligible, the remote tunnel endpoint may send a BSA allowed indication 124 to the local tunnel endpoint 121. The BSA allowed indication may be included in a reverse flow packet.

The first computer 120 may send a second forward flow packet 111 to the second computer 123. The second forward flow packet 111 may have a layer 2 header, a layer 3 header, a layer 4 header, and a layer 4 payload. The headers include static header fields and dynamic header fields. The static header fields contain the same header field values as those in the forward flow packet 101. The dynamic fields of the second forward flow packet 111 may contain values that are not the same as those in the forward flow packet 101. The layer 2 header may be an ethernet header 102 that is a static header field. The layer 3 header may be an IP packet header that has second dynamic IP fields 113 and static IP fields 104. The layer 4 header may be a TCP header, a user datagram protocol (UDP) header, or some other layer 4 header that has static layer 4 fields 106 and second dynamic layer 4 fields 115. The second forward flow packet 111 may have a second layer 4 payload 117 that may be a dynamic field.

The local tunnel endpoint 121 may receive the second forward flow packet 111 and determines that BSA is enabled for encapsulating the second forward flow packet 111. The local tunnel endpoint therefore creates a second encapsulating packet 119 that encapsulates an abbreviated packet 112 instead of encapsulating the second forward flow packet 111. The abbreviated packet 112 may include the dynamic header fields of the second forward flow packet 111 and may omit one or more of the static fields. As such, the static header fields of the second forward flow packet 111 are omitted from the second encapsulating packet and from the abbreviated packet 112. The second encapsulating packet 119 also includes the forward flow value 110 in a shim header 109.

The remote tunnel endpoint 122 may receive the second encapsulating packet 119 and may decapsulate the abbreviated packet 112. The remote tunnel endpoint stored the static header field values for the flow in the flow table entry while processing the forward flow packet 101. The remote tunnel endpoint 122 may therefore use the forward flow value 110 in the second encapsulating packet to access the flow table entry for the forward flow and obtain the static header field values for the forward flow. The remote tunnel endpoint may recover the second forward flow packet 111 by combining the static header field values for the forward flow with the dynamic header field values contained in the abbreviated packet 112. The remote tunnel endpoint may then send the second forward flow packet 111 to the second computer 123.

The static header fields in an IPv4 header may include the version, the source IP address, the destination IP address, and the protocol. The dynamic header fields in an IPv4 header may include the total length, the flags, and the time to live. The static header fields in an IPv6 header may include the source IP address, the destination IP address, the flow label, and the next header. The dynamic header fields in an IPv6 header may include the payload length and hop limit. The static header fields in a TCP or UDP header may include the source port and the destination port. The dynamic header fields in a TCP packet may include a sequence number, an acknowledgement number, flags, and checksum. In an example, the dynamic header fields in a packet are all the header fields that are not static header fields. In another example, the dynamic header fields in a packet are all the header fields that are not static header fields or pseudo-dynamic header fields. Pseudo-dynamic header fields are header fields that may change, but whose values may be calculated from the other packet contents. Examples of pseudo-dynamic header fields include checksums, packet length, time-to-live, etc. In some implementations, static header fields and pseudo-dynamic header fields may be omitted from the encapsulating packets. A tunnel endpoint may recover the pseudo-dynamic header fields while recovering a packet by combining the static header field values with the dynamic header field values contained in an abbreviated packet and computing the pseudo-dynamic header fields. A checksum or other error detection/recovery data for the abbreviated packet may be included in the shim header.

FIG. 1B is a high level conceptual diagram illustrating an example of tunnel endpoints using shim headers and an abbreviated packet to conserve network bandwidth in a reverse flow, according to some aspects. The local tunnel endpoint may calculate the reverse flow value 140 for the reverse flow and may create a flow table entry for the reverse flow while processing the forward flow packet. The flow table entry for the reverse flow may contain the static header field values that are expected to be in the reverse flow packets because, as is known by those practiced in computer networks, those static header field values may be derived from the first forward flow packet. Note that an alternative may be to wait for a reverse flow packet and to obtain the static header field values from that reverse flow packet. The remote tunnel endpoint may create a flow table entry for the reverse flow while processing the first encapsulating packet and may enable BSA for encapsulating reverse flow packets if the reverse flow is BSA eligible. In most instances, if a tunnel endpoint is already configured to process a different flow that has the same flow value as the forward flow, then the tunnel endpoint is also configured to process a different reverse flow (the reverse flow of the different flow) and that different reverse flow will have the same flow value as the reverse flow. As such, the reverse flow may always be BSA eligible if the forward flow is BSA eligible.

The second computer 123 may send a reverse flow packet 131 to the first computer 120. The reverse flow packet 131 may have a layer 2 header, a layer 3 header, a layer 4 header, and a layer 4 payload. The headers include static fields and dynamic fields. The layer 2 header may be a reverse flow ethernet header 132 that may be a static header field. The layer 3 header may be an IP packet header that has third dynamic IP fields 133 and reverse flow static IP fields 134. The layer 4 header may be a TCP header, a user datagram protocol (UDP) header, or some other layer 4 header that has reverse flow static layer 4 fields 136 and third dynamic layer 4 fields 135. The reverse flow packet 131 may have a third layer 4 payload 137 that may be a dynamic field.

The remote tunnel endpoint 122 may receive the reverse flow packet 131 and determines that BSA is enabled for encapsulating the reverse flow packet 131. The remote tunnel endpoint therefore creates a third encapsulating packet 138 that encapsulates a second abbreviated packet 141 instead of encapsulating the reverse flow packet 131. The second abbreviated packet 141 may be an example of an abbreviated reverse flow packet. The second abbreviated packet 141 includes the dynamic header fields of the reverse flow packet 131 but does not include the static header fields. As such, the static header fields of the reverse flow packet 131 are omitted from the third encapsulating packet and from the second abbreviated packet 141. The third encapsulating packet 138 also includes the reverse flow value 140 in a second shim header 139.

The local tunnel endpoint 121 may receive the third encapsulating packet 138 and may decapsulate the second abbreviated packet 141. The local tunnel endpoint may have stored the static header field values for the reverse flow in the reverse flow table entry while processing the forward flow packet 101. The local tunnel endpoint 121 may therefore use the reverse flow value 140 in the third encapsulating packet 138 to access the flow table entry for the reverse flow and obtain the static header field values for the reverse flow. The local tunnel endpoint may recover the reverse flow packet 131 by combining the static header field values for the reverse flow with the dynamic header field values contained in the second abbreviated packet 141. The local tunnel endpoint may then send the reverse flow packet 131 to the first computer 120.

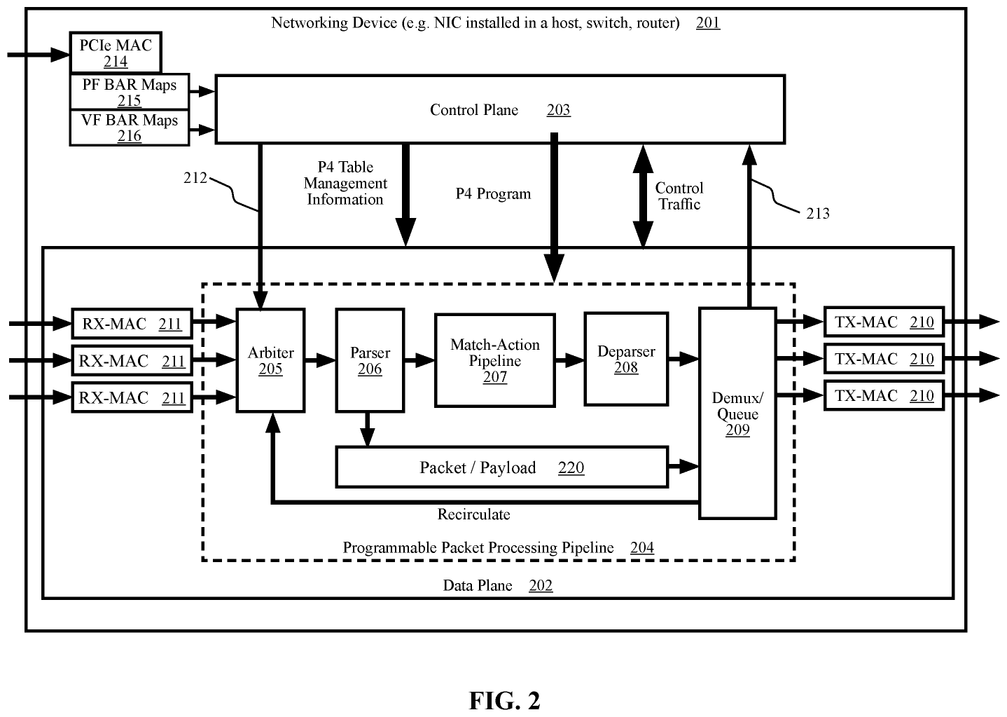

FIG. 2 is a high level functional block diagram illustrating an example of a networking device 201 having a control plane 203 and a data plane 202 and in which aspects may be implemented. A networking device 201 may have a control plane 203 implemented by a general purpose processor such as a central processing unit (CPU) containing one or more CPU cores. The networking device 201 may have a data plane 202 implemented by a special purpose circuit such as a packet processing pipeline circuit. The control plane may provide forwarding information (e.g., in the form of table management information or configuration data) to the data plane and the data plane may receive packets on input interfaces, may process the received packets, and then may forward the packets to desired output interfaces. Additionally, control traffic (e.g., in the form of packets) may be communicated from the data plane to the control plane and/or from the control plane to the data plane. In general, the control plane may be responsible for less frequent and less time-sensitive operations while the data plane is responsible for a high volume of time-sensitive forwarding decisions that need to be made at a rapid pace. For example, the control plane may implement processes that configure the data plane to process new flows and the data plane may implement operations related to parsing packet headers, Quality of Service (QOS), filtering, encapsulation, queuing, and policing. Although some functions of the control plane and data plane are described, other functions may be implemented in the control plane and/or the data plane.

Some techniques exist for providing flexibility at the data plane of networking devices that are used in data networks. For example, the concept of a domain-specific language for programming protocol-independent packet processors, known simply as “P4,” has developed to provide some flexibility at the data plane of a networking device. The document “P416 Language Specification,” published by the P4 Language Consortium is well known in the field and describes the P4 domain-specific language that may be used for programming the data plane of networking devices. P4 (also referred to herein as the “P4 specification,” the “P4 language,” and the “P4 program”) is designed to be implementable on a large variety of targets including switches, routers, programmable network interface cards (NICs), software switches, semiconductor chips, FPGAs, and ASICs. As described in the P4 specification, the primary abstractions provided by the P4 language relate to header types, parsers, tables, actions, match-action units, match-action pipeline stages, control flow, extern objects, user-defined metadata, and intrinsic metadata.

The data plane 202 may include multiple receive media access controllers 211 (RX-MACs) and multiple transmit media access controllers 210 (TX-MACs). The RX-MACs 211 may implement media access control on incoming packets via, for example, a layer 2 protocol such as Ethernet. The layer 2 protocol may be Ethernet and the RX-MACs may be configured to implement operations related to, for example, receiving frames, half-duplex retransmission and back-off functions, Frame Check Sequence (FCS), interframe gap enforcement, discarding malformed frames, and removing the preamble, Start Frame Delimiter (SFD), and padding from a packet. Likewise, the TX-MACs 210 may implement media access control on outgoing packets via, for example, Ethernet. The TX-MACs may be configured to implement operations related to, for example, transmitting frames, half-duplex retransmission, and back-off functions, appending an FCS, interframe gap enforcement, and prepending a preamble, an SFD, and padding.

As illustrated in FIG. 2, a P4 program may be provided to the data plane 202 via the control plane 203. Communications between the control plane and the data plane may use a dedicated channel or bus, may use shared memory, etc. The P4 program may include software code that configures the functionality of the data plane 202 to implement particular processing and/or forwarding logic and to implement processing and/or forwarding tables that are populated and managed via P4 table management information that may be provided to the data plane from the control plane. Control traffic (e.g., in the form of packets) may be communicated from the data plane to the control plane and/or from the control plane to the data plane. In the context of P4, the control plane corresponds to a class of algorithms and the corresponding input and output data that are concerned with the provisioning and configuration of the data plane. The data plane corresponds to a class of algorithms that describe transformations on packets by packet processing systems.

The data plane 202 may include a programmable packet processing pipeline 204 that may be programmable using a domain-specific language such as P4. As described in the P4 specification, a programmable packet processing pipeline may include an arbiter 205, a parser 206, a match-action pipeline 207, a deparser 208, and a demux/queue 209. The data plane elements described may be implemented as a P4 programmable switch architecture, as a P4 programmable NIC, as a P4 programmable router, or some other architecture. The arbiter 205 may act as an ingress unit receiving packets from RX-MACs 211 and may also receive packets from the control plane via a control plane packet input 212. The arbiter 205 may also receive packets that are recirculated to it by the demux/queue 209. The demux/queue 209 may act as an egress unit and may also be configured to send packets to a drop port (the packets thereby disappear), to the arbiter via recirculation, and to the control plane 203 via an output central processing unit (CPU) port 213. The arbiter 205 and the demux/queue 209 may be configured through the domain-specific language (e.g., P4).

The parser 206 may be a programmable element that may be configured through the domain-specific language (e.g., P4) to extract information from a packet (e.g., header field values from the header of the packet). As described in the P4 specification, parsers describe the permitted sequences of headers within received packets, how to identify those header sequences, and the headers and fields to extract from packets. The information extracted from a packet by the parser may be referred to as a packet header vector (PHV). The parser may identify certain fields of the header and may extract the data corresponding to the identified fields to generate the PHV. The PHV may include other data (often referred to as “metadata”) that is related to the packet but not extracted directly from the header, including for example, the port or interface on which the packet arrived at the networking device. Thus, the PHV may include other packet related data (metadata) such as input/output port number, input/output interface, or other data in addition to information extracted directly from the packet header. The PHV produced by the parser may have any size or length. For example, the PHV may be at least 4 bits, 8 bits, 16 bits, 32 bits, 64 bits, 128 bits, 256 bits, or 512 bits. In some cases, a PHV having even more bits (e.g., 6 Kb) may include all relevant header fields and metadata corresponding to a received packet. The size or length of a PHV corresponding to a packet may vary as the packet passes through the match-action pipeline.

The deparser 208 may be a programmable element that may be configured through the domain-specific language (e.g., P4) to generate packet headers from PHVs at the output of match-action pipeline 207 and to construct outgoing packets by reassembling the header(s) such as Ethernet headers, internet protocol (IP) headers, InfiniBand protocol data units (PDUs), etc. as determined by the match-action pipeline. In some cases, a packet/payload may travel in a separate queue or buffer 220, such as a first-in-first-out (FIFO) queue, until the packet payload may be reassembled with its corresponding PHV at the deparser to form a packet. The deparser may rewrite the original packet according to the PHV fields that have been modified (e.g., added, removed, or updated). In some cases, a packet processed by the parser may be placed in a packet buffer/traffic manager for scheduling and possible replication. In some cases, once a packet is scheduled and leaves the packet buffer/traffic manager, the packet may be parsed again to generate an egress PHV. The egress PHV may be passed through a match-action pipeline after which a final deparser operation may be executed (e.g., at deparser 208) after which the demux/queue 209 may send the packet to the TX-MAC 210 or recirculates it back to the arbiter 205 for additional processing.

A networking device 201 may have a peripheral component interconnect extended (PCIe) interface such as PCIe media access control (MAC) 214. A PCIe MAC may have a base address register (BAR) at a base address in a host system's memory space. Processes, typically device drivers within the host system's operating system, may communicate with a NIC via a set of registers beginning with the BAR. Some PCIe devices are single root input output virtualization (SR-IOV) capable. Such PCIe devices may have a physical function (PF) and a virtual function (VF). A PCIe SR-IOV capable device may have multiple VFs. A PF BAR map 215 may be used by the host machine to communicate with the PCIe card. A VF BAR map 216 may be used by a virtual machine (VM) running on the host to communicate with the PCIe card. Typically, the VM may access the NIC using a device driver within the VM and at a memory address within the VMs memory space. Many SR-IOV capable PCIe cards may map that location in the VM's memory space to a VF BAR. As such a VM may be configured as if it has its own NIC while in reality it may be associated with a VF provided by a SR-IOV capable NIC. As discussed below, some PCIe devices may have multiple PFs. For example, a NIC may provide network connectivity via one PF and may provide an InfiniBand channel adapter via another PF. As such, the NIC may provide “NIC” VFs and “InfiniBand” VFs to VMs running on the host. The InfiniBand PF and VFs may be used for data transfers, such as remote direct memory access (RDMA) transfers to other VMs running on the same or other host computers. Similarly, a NIC may provide non-volatile memory express (NVMe) and small computer system interface (SCSI) PFs and VFs to VMs running on the host.

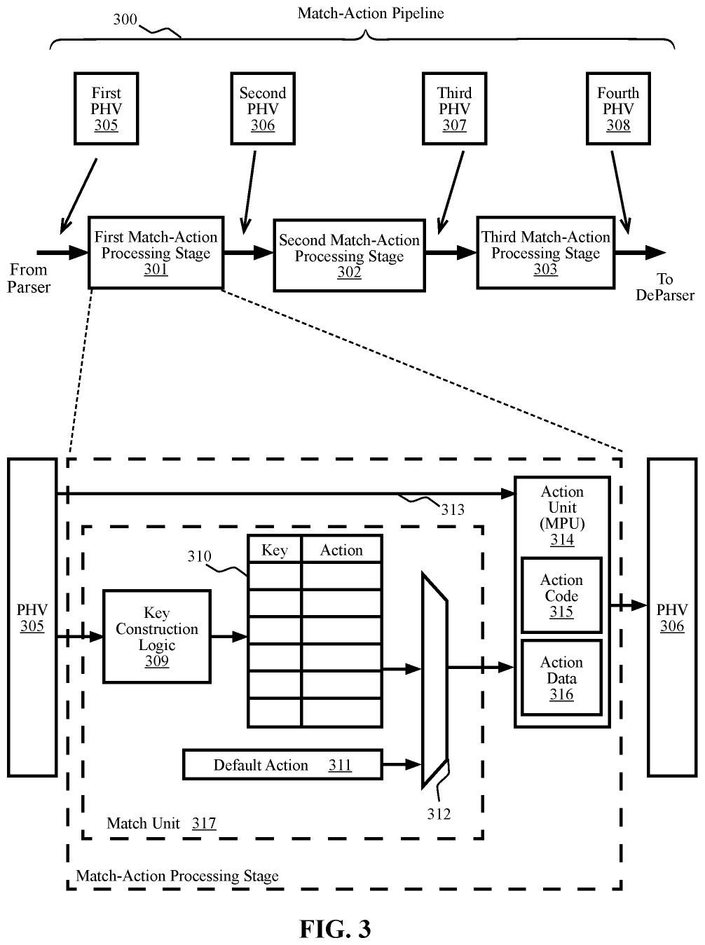

FIG. 3 is a functional block diagram illustrating an example of a match-action unit 301 in a match-action pipeline 300 according to some aspects. FIG. 3 introduces certain concepts related to match-action units and match-action pipelines and is not intended to be limiting. The match-action units are processing stages, often called stages or match-action processing stages, of the packet processing pipeline. The match-action processing stages 301, 302, 303 of the match-action pipeline 300 are programmed to perform “match-action” operations in which a match unit performs a lookup using at least a portion of the PHV and an action unit performs an action based on an output from the match unit. A PHV generated at the parser may be passed through each of the match-action processing stages in the match-action pipeline in series and each match-action processing stage may implement a match-action operation or policy. The PHV and/or table entries may be updated in each stage of match-action processing according to the actions specified by the P4 programming. In some instances, a packet may be recirculated through the match-action pipeline, or a portion thereof, for additional processing. The first match-action processing stage 301 may receive the first PHV 305 as an input and outputs the second PHV 306. The second match-action processing stage 302 may receive the second PHV 306 as an input and outputs the third PHV 307. The third match-action processing stage 303 may receive the third PHV 307 as an input and outputs the fourth PHV 308. The match-action processing stages are arranged as a match-action pipeline that passes the PHVs from one match-action processing stage to the next match-action processing stage in the pipeline.

An expanded view of elements of a match-action processing stage 301 of match-action pipeline 300 is shown. The match-action processing stage includes a match unit 317 (also referred to as a “table engine”) that operates on an input PHV 305 and an action unit 314 that produces an output PHV 306, which may be a modified version of the input PHV 305. The match unit 317 may include key construction logic 309, a lookup table 310, and selector logic 312. The key construction logic 309 may be configured to generate a key from at least one field in the PHV (e.g., 5-tuple, InfiniBand queue pair identifiers, etc.). The lookup table 310 may be populated with key-action pairs, where a key-action pair may include a key (e.g., a lookup key) and corresponding action code 315 and/or action data 316. A P4 lookup table may be viewed as a generalization of traditional switch tables, and may be programmed to implement, for example, routing tables, flow lookup tables, access control lists (ACLs), and other user-defined table types, including complex multi-variable tables. The key generation and lookup functions constitute the “match” portion of the operation and produce an action that may be provided to the action unit via the selector logic. The action unit executes an action over the input data (which may include data 313 from the PHV) and provides an output that forms at least a portion of the output PHV. For example, the action unit executes action code 315 on action data 316 and data 313 to produce an output that may be included in the output PHV 306. If no match is found in the lookup table, then a default action 311 may be implemented. A flow miss may be an example of a default action that may be executed when no match is found. The operations of the match-action processing stages may be programmable by the control plane via P4 and the contents of the lookup table (e.g., a flow table) may be managed by the control plane.

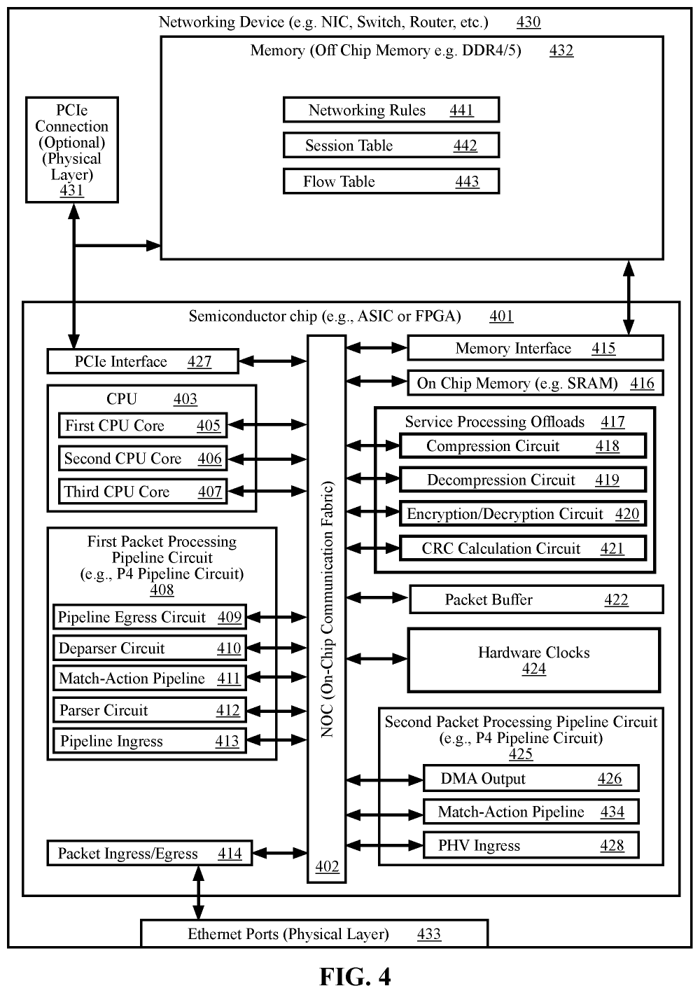

FIG. 4 is a functional block diagram of a networking device 430 having a semiconductor chip 401 such as an application specific integrated circuit (ASIC) or field programmable gate array (FPGA), according to some aspects. The local tunnel endpoint 121 and the remote tunnel endpoint 122 may each be a networking device such as networking device 430. The semiconductor chip 401 shows a single semiconductor chip implementing a large number of hardware functions. A different implementation may employ a chiplet architecture. A chiplet may be an active silicon die containing computational logic to perform all or part of a task. The task may be performed by a single active silicon die or by multiple active silicon dies operating together. The chiplets may be packaged together as a monolithic unit on the same substrate. A device having a chiplet architecture may have a programming model that conceptually treats numerous chiplets as a monolithic unit such that the individual chiplets are not exposed as distinct units to an application running on or using the device. If the networking device is a network interface card (NIC) then the NIC may be installed in a host computer and may act as a networking device for the host computer and for virtual machines running on the host computer. Such a NIC may have a PCIe connection 431 for communicating with the host computer via a host PCIe connection. The networking device 430 may have a semiconductor chip 401, off-chip memory 432, and ethernet ports 433. The off-chip memory 432 may be one of the widely available memory modules or chips such as double data rate 5 (DDR5) synchronous dynamic random-access memory (SDRAM) such that the semiconductor chip 401 has access to many gigabytes of memory on the networking device 430. The ethernet ports 433 provide physical connectivity to a computer network such as the internet. The NIC may include a printed circuit board to which the semiconductor chip 401 and the memory 432 are attached.

The semiconductor chip may have many core circuits interconnected by an on-chip communications fabric, sometimes called a network on a chip (NOC) 402. NOCs are often implementations of standardized communications fabrics such as the widely used advanced extensible interface (AXI) bus. The semiconductor chip's core circuits may include a PCIe interface 427, CPU 403, first packet processing pipeline circuit 408, packet ingress/egress circuits 414, memory interface circuit 415, on-chip memory 416 that may be a static random access memory (SRAM), service processing offloads 417, a packet buffer 422, hardware clocks 424, and a second packet processing pipeline circuit 425. The service processing offloads may include a compression circuit 418, a decompression circuit 419, an encryption/decryption circuit 420, and a cyclic redundancy check calculation circuit 421. The PCIe interface 427 may be used to communicate with a host computer via the PCIe connection 431. The CPU 403 may include numerous CPU cores such as a first CPU core 405, a second CPU core 406, and a third CPU core 407. The CPU 403 may implement the control plane of the networking device 430. The first packet processing pipeline circuit 408 may include a pipeline ingress circuit 413, a parser circuit 412, match-action pipeline 411, a deparser circuit 410, and a pipeline egress circuit 409. The second packet processing pipeline circuit 425 may include a PHV ingress circuit 428, a match-action pipeline 434, and a direct memory access (DMA) output circuit 426. The specific core circuits implemented within the non-limiting example of the semiconductor chip 401 may be selected such that the semiconductor chip implements many, perhaps all, of the functionality of an InfiniBand channel adapter, of an NVMe card, and of a networking device that may process network flows carried by internet protocol (IP) packets.

A network device may include precision clocks that output a precise time, clocks that are synchronized to remote authoritative clocks via precision time protocol (PTP), and hardware clocks 424. A hardware clock may provide a time value (e.g., year/day/hour/minute/second/ . . . ) or may simply be a counter that may be incremented by one at regular intervals (e.g., once per clock cycle for a device having a 10 nsec. clock period). Time values obtained from the clocks may be used as timestamps for events such as enqueuing/dequeuing a packet.

The first packet processing pipeline circuit 408 may be a specialized set of elements for processing PHVs including PHVs for network packets such as internet protocol (IP) packets and InfiniBand protocol data units (PDUs). The data plane may be implemented by a packet processing pipeline circuit such as the first packet processing pipeline circuit 408. The first packet processing pipeline circuit 408 may be a P4 packet processing pipeline circuit that implements a P4 pipeline that may be configured using a domain-specific language such as the P4 domain specific language. As described in the P4 specification, the primary abstractions provided by the P4 language relate to header types, parsers, tables, actions, match-action units, control flow, extern objects, user-defined metadata, and intrinsic metadata.

The second packet processing pipeline circuit 425 may be a specialized set of elements for processing PHVs including PHVs for network packets such as internet protocol (IP) packets and InfiniBand protocol data units (PDUs). The second packet processing pipeline circuit 425 may be a P4 packet processing pipeline circuit that implements a P4 pipeline that may be configured using a domain-specific language such as the P4 domain specific language. As described in the P4 specification, the primary abstractions provided by the P4 language relate to header types, parsers, tables, actions, match-action units, control flow, extern objects, user-defined metadata, and intrinsic metadata. The data plane may be implemented by the first packet processing pipeline circuit 408 in combination with the second packet processing pipeline circuit 425.

The networking device 430 may include a memory 432 for running Linux or some other operating system and for storing data used by the processes implementing network services, upgrading the control plane, and upgrading the data plane. The networking device may use the memory 432 to store networking rules 441, a session table 442, and a flow table 443. The control plane, which may be implemented by the CPU 403, may use the network rules to determine how a packet may be processed, may process that packet, and may create a flow table entry for the flow that includes that packet. The flow table entry may include directives (e.g., P4 instructions and data) that the data plane, which may be implemented by the packet processing pipeline circuit 408, uses for processing packets in the flow. The session table 442 may contain session table entries for sessions. A session (e.g., a TCP session) may be the communications between two computers and may therefore have a forward flow and a reverse flow. The session table entry may include data for tracking session state, storing metrics related to the session, etc.

The CPU cores 405, 406, 407 may be general purpose processor cores, such as ARM processor cores and/or x86 processor cores, as is known in the field. Each CPU core may include an arithmetic logic unit (ALU), a register bank, an instruction fetch unit, and an instruction decoder, which are configured to execute instructions independently of the other CPU cores. The CPU cores may be Reduced Instruction Set Computers (RISC) CPU cores that are programmable using a general-purpose programming language such as C.

There may be multiple CPU cores 405, 406, 407 available for control plane functions and for implementing aspects of a slow data path that includes software implemented packet processing functions. The CPU cores may be used to implement discrete packet processing operations such as layer 7 applications (e.g., layer 7 load balancing, layer 7 firewalling, and/or layer 7 telemetry), certain InfiniBand channel adapter functions, flow table insertion or table management events, connection setup/management, multicast group join, deep packet inspection (DPI) such as uniform resource locator (URL) inspection, storage volume management (e.g., NVMe volume setup and/or management), encryption, decryption, compression, and decompression, which may not be readily implementable through a domain-specific language such as P4, in a manner that provides fast path performance as may be expected of data plane processing.

The packet buffer 422 may act as a central on-chip packet switch that delivers packets from the network interfaces 433 to packet processing elements of the data plane and vice-versa. The packet processing elements may include a slow data path implemented in software and a fast data path implemented by a packet processing pipeline circuits 408, 425.

The first packet processing pipeline circuit 408 may be a specialized circuit or part of a specialized circuit using one or more semiconductor chips such as ASICs or FPGAs to implement programmable packet processing pipelines such as the programmable packet processing pipeline 204 of FIG. 2. Some networking devices include semiconductor chips such as ASICs or FPGAs implementing a P4 pipeline of a data plane within the networking device.

All data transactions in the semiconductor chip 401, including on-chip memory transactions, and register reads/writes may be performed via a coherent interconnect 402. In one non-limiting example, the coherent interconnect may be provided by a network on a chip (NOC) “IP core”. Semiconductor chip designers may license and use prequalified IP cores within their designs. Prequalified IP cores may be available from third parties for inclusion in chips produced using certain semiconductor fabrication processes. A number of vendors provide NOC IP cores. The NOC may provide cache coherent interconnect between the NOC masters, including the first packet processing pipeline circuit 408, the second packet processing pipeline circuit 425, CPU 403, memory interface circuit 415, and PCIe interface 427. The interconnect may distribute memory transactions across a plurality of memory interfaces using a programmable hash algorithm. All traffic targeting the memory may be stored in a NOC cache (e.g., 1 megabyte cache). The NOC cache may be kept coherent with the CPU core caches.

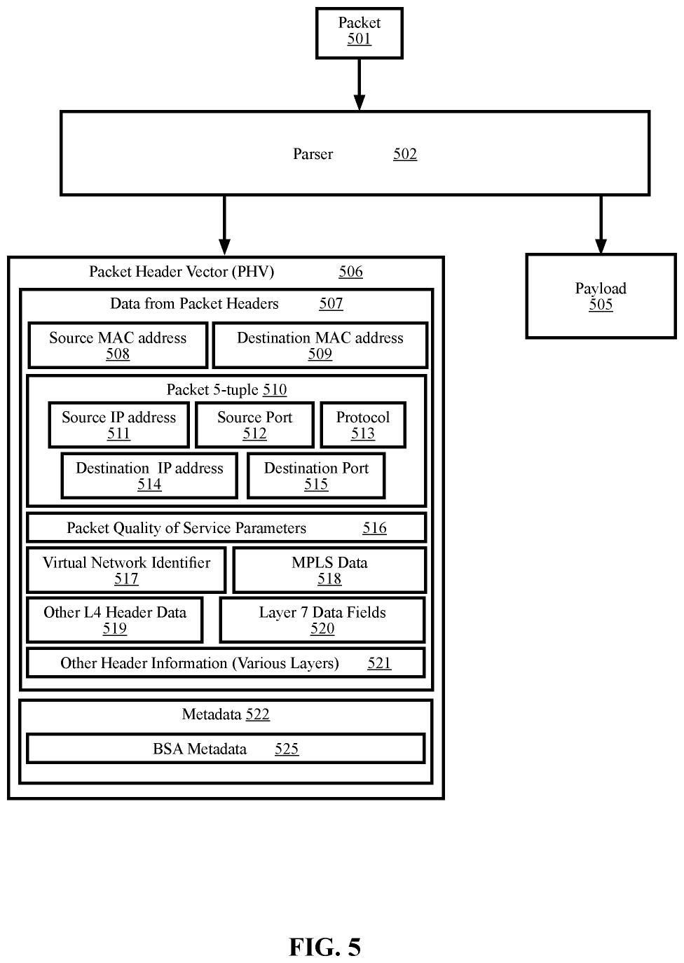

FIG. 5 is a high-level diagram illustrating an example of generating an ingress packet header vector 506 from a packet 501 according to some aspects. The PHV 506 may be an ingress PHV that may be produced by a parser 502 parsing a packet 501 received via an ingress port as a bit stream. The parser 502 may receive a packet 501 that has layer 2, layer 3, layer 4, and layer 7 headers and payloads. The parser may generate a packet header vector (PHV) from packet 501. The packet header vector 506 may include many data fields including data from packet headers 507 and metadata 522. The metadata 522 may include data generated by the networking device such as the hardware port on which the packet 501 was received and the packet timestamps indicating when the packet 501 was received by the networking device, enqueued, dequeued, etc. The metadata 522 may also include data produced by the networking device while processing a packet or assembling a packet. Such metadata 522 may include BSA metadata 525 (e.g., flow value, control bit, key bit).

The source MAC address 508 and the destination MAC address 509 may be obtained from the packet's layer 2 header. The source IP address 511 may be obtained from the packet's layer 3 header. The source port 512 may be obtained from the packet's layer 4 header. The protocol 513 may be obtained from the packet's layer 3 header. The destination IP address 514 may be obtained from the packet's layer 3 header. The destination port 515 may be obtained from the packet's layer 4 header. The packet quality of service parameters 516 may be obtained from the packet's layer 3 header or another header based on implementation specific details. The layer 4 header data 517 may be obtained from the packet's layer 4 header. The multi-protocol label switching (MPLS) data 518, such as an MPLS label, may be obtained from the packet's layer 2 header. The layer 7 header data 519 may be obtained from the packet's layer 7 header. The other layer 7 data fields 520 may be obtained from the packet's layer 7 payload. The other header information 521 may be the other information contained in the packet's layer 2, layer 3, layer 4, and layer 7 headers.

The packet 5-tuple 510 may be used for generating keys for looking up and reading entries in key-value tables such as flow tables. The packet 5-tuple 510 may include the source IP address 511, the source port 512, the protocol 513, the destination IP address 514, and the destination port 515.

Those practiced in computer networking protocols realize that the headers carry much more information than that described here, realize that substantially all of the headers are standardized by documents detailing header contents and fields, and know how to obtain those documents. The parser may also be configured to output a payload 505. Recalling that the parser 502 may be a programmable element that may be configured through the domain-specific language (e.g., P4) to extract information from a packet, the specific contents of the payload 505 are those contents specified via the domain specific language. For example, the contents of the payload 505 may be the layer 4 payload, the layer 7 payload, etc.

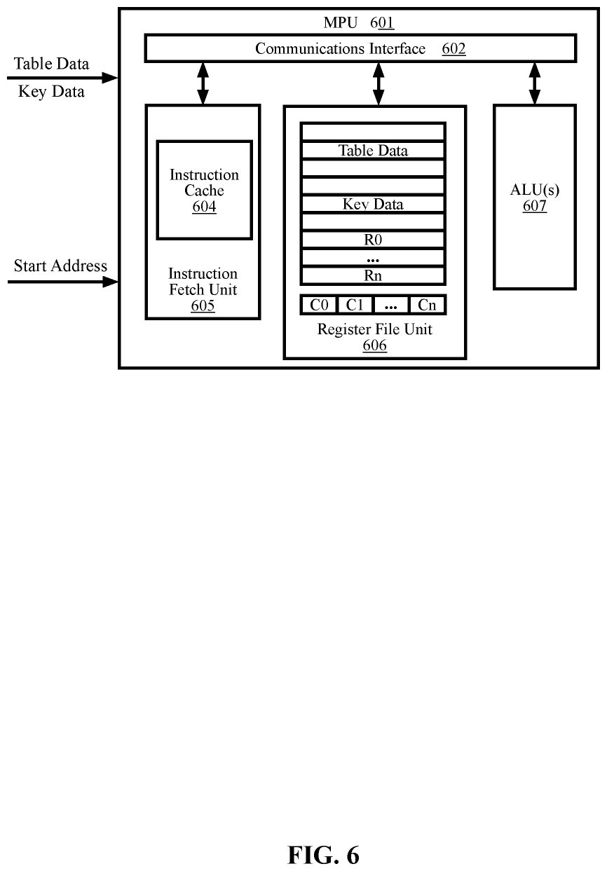

FIG. 6 illustrates a block diagram of a match processing unit (MPU) 601, also referred to as an action unit, that may be used within the exemplary system of FIG. 4 to implement some aspects. The MPU 601 may have multiple functional units, memories, and a register file. For example, the MPU 601 may have an instruction fetch unit 605, a register file unit 606, a communication interface 602, arithmetic logic units (ALUs) 607 and various other functional units.

In the illustrated example, the MPU 601 may have a write port or communication interface 602 allowing for memory read/write operations. For instance, the communication interface 602 may support packets written to or read from an external memory or an internal static random-access memory (SRAM). The communication interface 602 may employ any suitable protocol such as advanced extensible interface (AXI) protocol. AXI is a high-speed/high-end on-chip bus protocol and has channels associated with read, write, address, and write response, which are respectively separated, individually operated, and have transaction properties such as multiple-outstanding address or write data interleaving. The AXI interface 602 may include features that support unaligned data transfers using byte strobes, burst based transactions with only start address issued, separate address/control and data phases, issuing of multiple outstanding addresses with out of order responses, and easy addition of register stages to provide timing closure. For example, when the MPU executes a table write instruction, the MPU may track which bytes have been written to (a.k.a. dirty bytes) and which remain unchanged. When the table entry is flushed back to the memory, the dirty byte vector may be provided to AXI as a write strobe, allowing multiple writes to safely update a single table data structure as long as they do not write to the same byte. In some cases, dirty bytes in the table need not be contiguous and the MPU may only write back a table if at least one bit in the dirty vector is set. Though packet data may be transferred according the AXI protocol in the on-chip communications fabric system according to the examples in the present specification, it may also be applied to a packet data communication on-chip interconnect system operating by other protocols supporting a lock operation, such as advanced high-performance bus (AHB) protocol or advanced peripheral bus (APB) protocol in addition to the AXI protocol.

The MPU 601 may have an instruction fetch unit 605 configured to fetch instructions from a memory external to the MPU based on the table lookup result or at least a portion of the table lookup result. The instruction fetch unit may support branches and/or linear code paths based on table results or a portion of a table result provided by a table engine. In some cases, the table result may comprise table data, key data and/or a start address of a set of instructions/program. The instruction fetch unit 605 may have an instruction cache 604 for storing one or more programs. In some cases, the one or more programs may be loaded into the instruction cache 604 upon receiving the start address of the program provided by the table engine. In some cases, a set of instructions or a program may be stored in a contiguous region of a memory unit, and the contiguous region may be identified by the address. In some cases, the one or more programs may be fetched and loaded from an external memory via the communication interface 602. This provides flexibility to allow for executing different programs associated with different types of data using the same processing unit. In an example, a management PHV may be injected into the pipeline, for example to perform administrative table direct memory access (DMA) operations or entry aging functions (e.g., adding timestamps), one of the management MPU programs may be loaded to the instruction cache to execute the management function. The instruction cache 604 may be implemented using various types of memories such as one or more SRAMs.

The one or more programs may be any programs such as P4 programs related to reading table data, building headers, DMA to/from memory, writing to/from memory, and various other actions. The one or more programs may be executed in any match-action processing stage.

The MPU 601 may have a register file unit 606 to stage data between the memory and the functional units of the MPU, or between the memory external to the MPU and the functional units of the MPU. The functional units may include, for example, ALUs, meters, counters, adders, shifters, edge detectors, zero detectors, condition code registers, status registers, etc. In some cases, the register file unit 606 may comprise a plurality of general-purpose registers (e.g., R0, R1, . . . . Rn) which may be initially loaded with metadata values then later used to store temporary variables within execution of a program until completion of the program. For example, the register file unit 606 may be used to store SRAM addresses, ternary content addressable memory (TCAM) search values, ALU operands, comparison sources, or action results. The register file unit of a stage may also provide data/program context to the register file of the subsequent stage, as well as making data/program context available to the next stage's execution data path (e.g., the source registers of the next stage's adder, shifter, etc.). In some MPUs, each register of the register file may be 64 bits and may be initially loaded with special metadata values such as hash value from table lookup, packet size, PHV timestamp, programmable table constant, etc.

The register file unit 606 may have a comparator flags unit (e.g., C0, C1, . . . . Cn) configured to store comparator flags. The comparator flags may be set by calculation results generated by the ALU which in return may be compared with constant values in an encoded instruction to determine a conditional branch instruction. The MPU may have one-bit comparator flags (e.g., 8 one-bit comparator flags). In practice, an MPU may have any number of comparator flag units, each of which may have any suitable length.

The MPU 601 may have one or more functional units such as the ALU(s) 607. An ALU may support arithmetic and logical operations on the values stored in the register file unit 606. The results of the ALU operations (e.g., add, subtract, AND, OR, XOR, NOT, AND NOT, shift, and compare) may then be written back to the register file. The functional units of the MPU may, for example, update or modify fields anywhere in a PHV, write to memory (e.g., table flush), or perform operations that are not related to PHV update. For example, an ALU may be configured to perform calculations on descriptor rings, scatter gather lists (SGLs), and control data structures loaded into the general purpose registers from the host memory.

The MPU may be capable of locking a table. In some cases, a table being processed by an MPU may be locked or marked as “locked” in the table engine. For example, while an MPU has a table loaded into its register file, the table address may be reported back to the table engine, causing future reads to the same table address to stall until the MPU has released the table lock. For instance, the MPU may release the lock when an explicit table flush instruction is executed, the MPU program ends, or the MPU address is changed. In some cases, an MPU may lock more than one table address, for example, one for the previous table write-back and another address lock for the current MPU program.

A single MPU may be configured to execute instructions of a program until completion of the program. Multiple MPUs may be configured to execute a program. A table result may be distributed to multiple MPUs. The table result may be distributed to multiple MPUs according to an MPU distribution mask configured for the tables. This may provide advantages to prevent data stalls or mega packets per second (MPPS) decrease when a program is too long. For example, if a PHV requires four table reads in one stage, then each MPU program may be limited to only eight instructions in order to maintain a 100 MPPS if operating at a frequency of 800 megahertz (MHz) in which scenario multiple MPUs may be desirable.

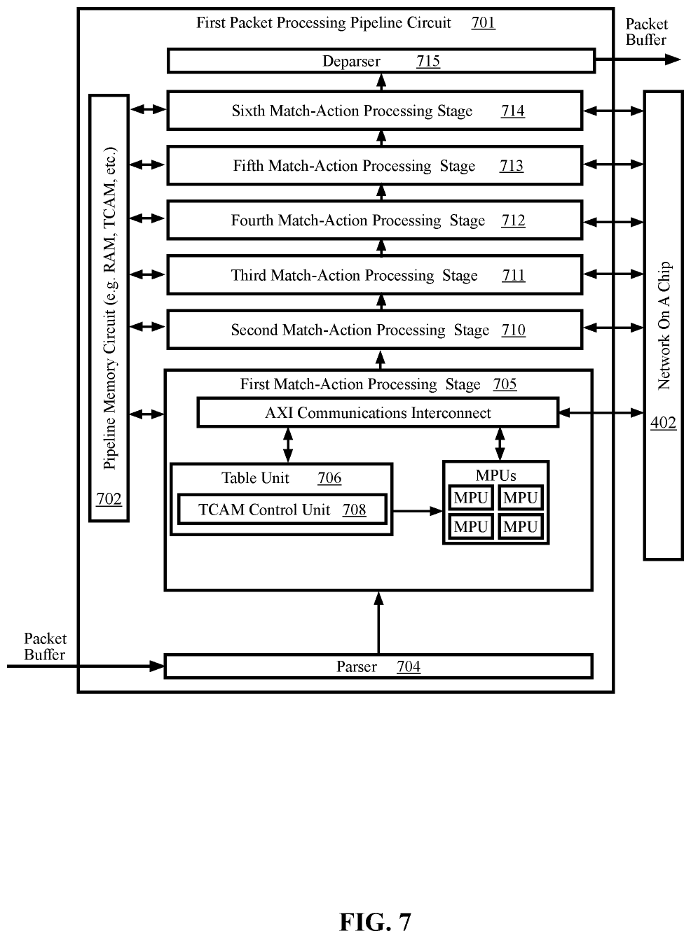

FIG. 7 illustrates a block diagram of a packet processing pipeline circuit 701 that may be included in the exemplary system of FIG. 4. The packet processing pipeline circuit 701 may be a P4 pipeline circuit in a semiconductor chip. Each processing stage 705. 710, 711, 712, 713, 714 of the packet processing pipeline circuit 701 may be the same as the other processing stages of the packet processing pipeline circuit. Furthermore, each processing stage may be directly connected on-chip to a previous processing stage, to a subsequent processing stage, or to both. For example, the third match action stage 711 may receive the output of the second processing stage 710 directly from the second processing stage 710 and the fourth match action stage 712 may receive the output of the third processing stage 711 directly from the third processing stage 711. As such, the packet processing pipeline circuit may be configured to process packets by clocking PHVs directly through the processing stages beginning with the first stage and ending with the last stage. Furthermore, the pipeline may be configured such that a processing stage output cannot be passed into a subsequent processing stage other than the immediately subsequent processing stage. For example, the output of the second processing stage may be unable to pass into the fourth processing stage without first passing through the third processing stage. The packet processing pipeline circuit 701 may be programmed to provide various features, including, but not limited to, routing, bridging, tunneling, forwarding, network ACLs, layer 4 firewalls, flow based rate limiting, VLAN tag policies, membership, isolation, multicast and group control, label push/pop operations, layer 4 load balancing, layer 4 flow tables for analytics and flow specific processing, distributed denial of service (DDOS) attack detection, mitigation, telemetry data gathering on any packet field or flow state and various others.

A programmer or compiler may decompose a packet processing program or flow processing data into a set of dependent or independent table lookup and action processing stages (e.g., match-action) that may be mapped onto the table engine and MPU stages. The match-action pipeline may have a plurality of stages. For example, a packet entering the pipeline may be first parsed by a parser stage (e.g., parser 704) according to the packet header stack specified by a P4 program. This parsed representation of the packet may be referred to as a packet header vector (PHV). The PHV may then be passed through match-action processing stages (e.g., match-action processing stages 705, 710, 711, 712, 713, 714) of the match-action pipeline. Each match-action processing stage may be configured to match one or more PHV fields to tables and to update the PHV, table entries, or other data according to the actions specified by the P4 program. If the required number of stages exceeds the implemented number of stages, a packet may be recirculated for additional processing. The packet payload may travel in a separate queue or buffer until it may be reassembled with its PHV in a deparser 715. The deparser 715 may rewrite the original packet according to the PHV fields which may have been modified in the pipeline. A packet processed by an ingress pipeline may be placed in a packet buffer for scheduling and possible replication. In some cases, once the packet is scheduled and leaves the packet buffer, it may be parsed again to create an egress PHV. The egress PHV may be passed through a P4 egress pipeline in a similar fashion as a packet passing through a P4 ingress pipeline, after which a final deparser operation may be executed before the packet may be sent to its destination interface or recirculated for additional processing. The networking device 430 of FIG. 4 may have a P4 pipeline that may be implemented via a packet processing pipeline circuit 701.

A pipeline may have multiple parsers and may have multiple deparsers. The parser may be a P4 compliant programmable parser and the deparser may be a P4 compliant programmable deparser. The parser may be configured to extract packet header fields according to P4 header definitions and place them in a PHV. The parser may select from any fields within the packet and align the information from the selected fields to create the PHV. The deparser may be configured to rewrite the original packet according to an updated PHV. The pipeline MPUs of the match-action processing stages 705, 710, 711, 712, 713, 714 may be the same as the MPU 601 of FIG. 6. Match-action processing stages may have any number of MPUs. The match-action processing stages of a match-action pipeline may all be identical.

A table engine 706 may be configured to support per-stage table match. For example, the table engine 706 may be configured to hash, lookup, and/or compare keys to table entries. The table engine 706 may be configured to control the address and size of the table, use PHV fields to generate a lookup key, and find Session Ids or MPU instruction pointers that define the P4 program associated with a table entry. A table result produced by the table engine may be distributed to the multiple MPUs.

The table engine 706 may be configured to control a table selection. In some cases, upon entering a stage, a PHV may be examined to select which table(s) to enable for the arriving PHV. Table selection criteria may be determined based on the information contained in the PHV. In some cases, a match table may be selected based on packet type information related to a packet type associated with the PHV. For instance, the table selection criteria may be based on a debug flag, packet type or protocols (e.g., Internet Protocol version 4 (IPv4), Internet Protocol version 6 (IPv6), multiprotocol label switching (MPLS), or the next table ID as determined by the preceding stage. In some cases, the incoming PHV may be analyzed by the table selection logic, which then generates a table selection key and compares the result using a TCAM to select the active tables. A table selection key may be used to drive table hash generation, table data comparison, and associated data into the MPUs.

The table engine 706 may have a ternary content-addressable memory (TCAM) control unit 708. The TCAM control unit may be configured to allocate memory to store multiple TCAM search tables. In an example, a PHV table selection key may be directed to a TCAM search stage before a SRAM lookup. The TCAM control unit may be configured to allocate TCAMs to individual pipeline stages to prevent TCAM resource conflicts, or to allocate TCAM into multiple search tables within a stage. The TCAM search index results may be forwarded to the table engine for SRAM lookups.

The table engine 706 may be implemented by hardware or circuitry. The table engine may be hardware defined. In some cases, the results of table lookups or table results are provided to the MPU in its register file.

A match-action pipeline may have multiple match-action processing stages such as the six units illustrated in the example of FIG. 7. In practice, a match-action pipeline may have any number of match-action processing stages. The match-action processing stages may share a pipeline memory circuit 702 that may be static random-access memory (SRAM), TCAM, some other type of memory, or a combination of different types of memory. The packet processing pipeline circuit stores data in the pipeline memory circuit. For example, the packet processing pipeline circuit may store a table in the pipeline memory circuit that configures the packet processing pipeline circuit to process specific network flows. For example, a flow table or multiple flow tables may be stored in the pipeline memory circuit 702 and may store instructions and data that the packet processing pipeline circuit uses to process a packet.

The second match-action pipeline circuit 425 includes a match-action pipeline 434. That match-action pipeline 434 may include match-action processing stages such as match-action processing stages 705, 710, 711, 712, 713, 714.

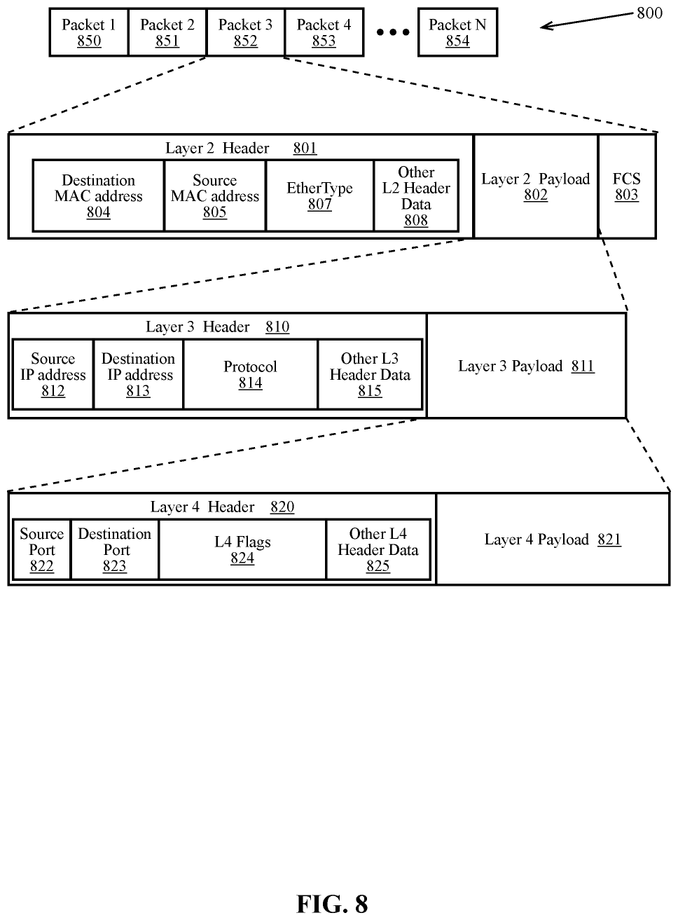

FIG. 8 is a high level conceptual diagram illustrating an example of packet headers and payloads of packets for network traffic flows, according to some aspects. A group of network packets passing from one specific endpoint to another specific endpoint may be a network flow. A network flow 800 may have numerous network packets such as a first packet 850, a second packet 851, a third packet 852, a fourth packet 853, and a final packet 854 with many more packets between the fourth packet 853 and the final packet 854. The term “the packet” or “a packet” may refer to any of the network packets in a network flow.

Packets may be constructed and interpreted in accordance with the internet protocol suite. The Internet protocol suite is the conceptual model and set of communications protocols used in the Internet and similar computer networks. A packet may be transmitted and received as a raw bit stream over a physical medium at the physical layer, sometimes called layer 1. The packets may be received by a RX-MAC 211 as a raw bit stream or transmitted by TX-MAC 210 as a raw bit stream.

The link layer is often called layer 2. The protocols of the link layer operate within the scope of the local network connection to which a host may be attached and includes all hosts accessible without traversing a router. The link layer may be used to move packets between the interfaces of two different hosts on the same link. The packet (an Ethernet packet is shown) has a layer 2 header 801, a layer 2 payload 802, and a layer 2 frame check sequence (FCS) 803. The layer 2 header may contain a source MAC address 805, a destination MAC address 804, an ethertype 807, and other layer 2 header data 808. The input ports 211 and output ports 210 of a networking device 201 may have MAC addresses. A networking device 201 may have a MAC address that may be applied to all or some of the ports. Alternatively, a networking device may have one or more ports that each have their own MAC address. In general, each port may send and receive packets. As such, a port of a networking device may be configured with a RX-MAC 211 and a TX-MAC 210. Ethernet, also known as Institute of Electrical and Electronics Engineers (IEEE) 802.3, is a layer 2 protocol. IEEE 802.11 (WIFI) is another widely used layer 2 protocol. The layer 2 payload 802 may include a layer 3 packet. The layer 2 FCS 803 may include a CRC (cyclic redundancy check) calculated from the layer 2 header and layer 2 payload. The layer 2 FCS may be used to verify that the packet has been received without errors.

The internet layer, often called layer 3, is the network layer where layer 3 packets may be routed from a first node to a second node across multiple intermediate nodes. The nodes may be networking devices such as networking device 201. Internet protocol (IP) is a commonly used layer 3 protocol that is specified in requests for comment (RFCs) published by the Internet Engineering Task Force (IETF). More specifically, the format and fields of IP packets are specified by IETF RFC 791. The layer 3 packet (an IP packet is shown) may have a layer 3 header 810 and a layer 3 payload 811. The layer 3 header of an IP packet is an IP header and the layer 3 payload of an IP packet is an IP payload. The layer 3 header 810 may have a source IP address 812, a destination IP address 813, a protocol indicator 814, and other layer 3 header data 815. In general, a packet may be directed from a source machine at the source IP address 812 and may be directed to the destination machine at the destination IP address 813. As an example, a first node may send an IP packet to a second node via an intermediate node. The IP packet therefore has a source IP address indicating the first node and a destination IP address indicating the second node. The first node may make a routing decision to send the IP packet to the intermediate node. The first node may therefore send the IP packet to the intermediate node in a first layer 2 packet. The first layer 2 packet has a source MAC address 805 indicating the first node, a destination MAC address 804 indicating the intermediate node, and has the IP packet as a payload. The intermediate node may receive the first layer 2 packet. Based on the destination IP address, the intermediate node may make a routing decision to send the IP packet to the second node. The intermediate node may then send the IP packet to the second node in a second layer 2 packet having a source MAC address 805 indicating the intermediate node, a destination MAC address 804 indicating the second node, and the IP packet as a payload. The layer 3 payload 811 may include headers and payloads for higher layers in accordance with higher layer protocols such as transport layer protocols.

The transport layer, often called layer 4, may establish basic data channels that applications use for task-specific data exchange and may establish host-to-host connectivity. A layer 4 protocol may be indicated in the layer 3 header 810 using protocol indicator 814. Transmission control protocol (TCP, specified by IETF RFC 793), user datagram protocol (UDP, specified by IETF RFC 768), and internet control message protocol (ICMP), specified by IETF RFC 792) are common layer 4 protocols. TCP is often referred to as TCP/IP. TCP is connection oriented and may provide reliable, ordered, and error-checked delivery of a stream of bytes between applications running on hosts communicating via an IP network. When carrying TCP data, a layer 3 payload 811 includes a TCP header and a TCP payload. UDP may provide for computer applications to send messages, in this case referred to as datagrams, to other hosts on an IP network using a connectionless model. When carrying UDP data, a layer 3 payload 811 includes a UDP header and a UDP payload. ICMP may be used by network devices, including routers, to send error messages and operational information indicating success or failure when communicating with another IP address. ICMP uses a connectionless model.

A layer 4 packet (a TCP packet is shown) may have a layer 4 header 820 (a TCP header is shown) and a layer 4 payload 821. The layer 4 header 820 may include a source port 822, destination port 823, layer 4 flags 824, and other layer 4 header data 825. The source port and the destination port may be integer values used by host computers to deliver packets to application programs configured to listen to and send on those ports. The layer 4 flags 824 may indicate a status of or action for a network flow. A layer 4 payload 821 may contain a layer 7 packet. The application layer, often called layer 7, includes the protocols used by most applications for providing user services or exchanging application data over the network connections established by the lower level protocols. Examples of application layer protocols include NVMe/TCP, RDMA over Converged Ethernet version 2, (RoCE v2), Hypertext Transfer Protocol (HTTP), File Transfer Protocol (FTP), Simple Mail Transfer Protocol (SMTP), and Dynamic Host Configuration (DHCP). Data coded according to application layer protocols may be encapsulated into transport layer protocol data units (such as TCP or UDP messages), which in turn use lower layer protocols to effect actual data transfer.

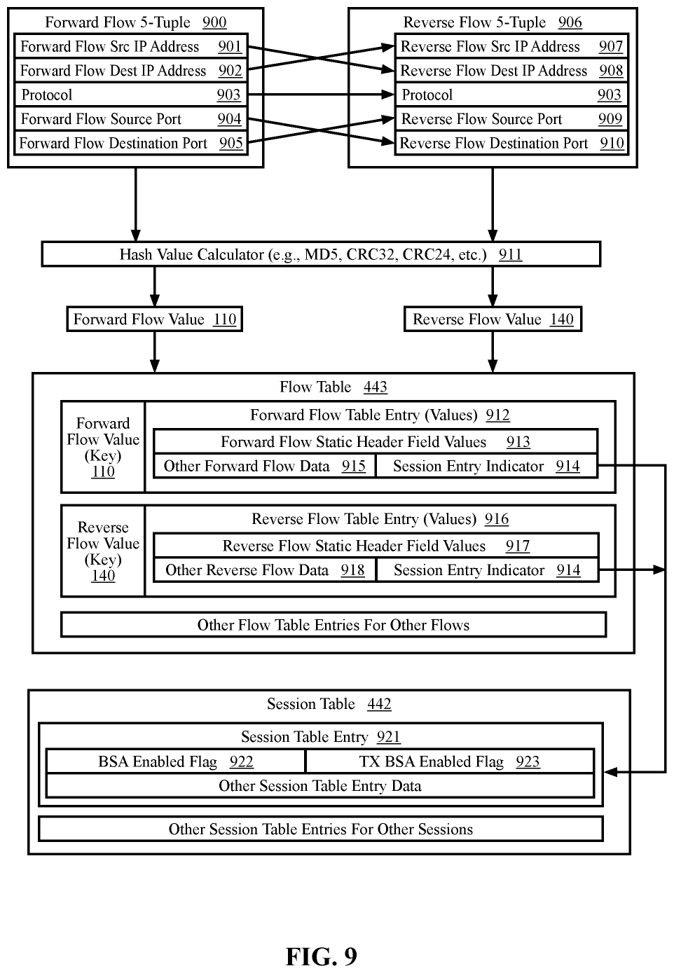

FIG. 9 is a high level conceptual diagram illustrating an example of producing a forward flow table entry, a reverse flow table entry, and a session table entry, according to some aspects. The static header fields of a packet (e.g., TCP/IP packet, UDP/IP packet, etc.) may include a packet 5-tuple such as forward flow 5-tuple 900. The forward flow 5-tuple 900 may have a forward flow source address value 901 (e.g., the IP address of the first computer 120) in the source address field 812, a forward flow destination address value 902 (e.g., the IP address of the second computer 123) in the destination address field 813, a protocol indicator value 903 in the protocol indicator field 814, a forward flow source port value 904 in the source port field 822, and a forward flow destination port value 905 in the destination port field 823. All the packets in the forward flow may have the forward flow 5-tuple in their packet headers. A session, such as a TCP session or a UDP session, may have a forward flow and a reverse flow. The 5-tuple for the reverse flow of a session may contain the same header field values as the 5-tuple for the forward flow, but in different header fields. The header fields in the forward flow 5-tuple 900 may therefore be used to generate a reverse flow 5-tuple 906. The reverse flow 5-tuple 906 may have a reverse flow source address value 907 that may be equal to the forward flow destination address value 902, a reverse flow destination address value 908 that may be equal to the forward flow source address value 901, a protocol indicator value 903 that may be the same as the protocol indicator value 903 in the forward flow 5-tuple 900, a reverse flow source port value 909 that may be equal to forward flow destination port value 905, and a reverse flow destination port value 910 that may be equal to the forward flow source port value 904.

A hash value calculator 911 may output a forward flow value 110 in response to receiving the forward flow 5-tuple 900 as an input. The hash value calculator 911 may also output a reverse flow value 140 in response to receiving the reverse flow 5-tuple 906 as an input. For example, the hash value calculator may use the input to calculate a 20 bit cyclic redundancy check (CRC) value and then use 16 bits of the 20 bits (e.g., the 16 least significant bits) to produce a 16 bit flow value. A forward flow table entry 912 may be stored in a flow table 443 corresponding to the forward flow value 110 and a reverse flow table entry 916 may be stored in the flow table 443 corresponding to the reverse flow value 140. For example, the flow table may be a key-value table that stores values (e.g., the flow table entries) corresponding to keys (e.g., the flow values). A flow value may be used to access a flow table entry after the flow table entry has been stored corresponding to the flow value in the flow table. The forward flow table entry 912 may include forward flow static header field values 913 (e.g., the forward flow 5-tuple, the forward flow ethernet header, etc.), other forward flow data 915, and a session table entry indicator 914. The reverse flow table entry 916 may include reverse flow static header field values 917 (e.g., the reverse flow 5-tuple, the reverse flow ethernet header, etc.), other reverse flow data 918, and a session table entry indicator 914. The other forward flow data 915 may include directives and metadata that the data plane uses for processing forward flow packets. The other reverse flow data 918 may include directives and metadata that the data plane uses for processing reverse flow packets. The forward flow and the reverse flow may be the flows in a session. Data related to the session may be stored as a session table entry 921 in a session table 442. The session table entry indicator 914 may be used to access the session table entry 921 in the session table. For example, the session table may be a key-value table where the session table entry indicators are the keys and the session table entries are the values. Each session table entry may be stored corresponding to the session table entry indicator in a session table. The session table may include a bandwidth saving aspect (BSA) enabled flag 922 and a TX BSA enabled flag 923. The BSA enabled flag 922 may indicate that the flows in the session are BSA eligible and that BSA metadata may be included in encapsulating packets for the flows. The TX BSA enabled flag 923 may indicate that static header fields may be omitted from the encapsulating packets transmitted to the other tunnel endpoint.

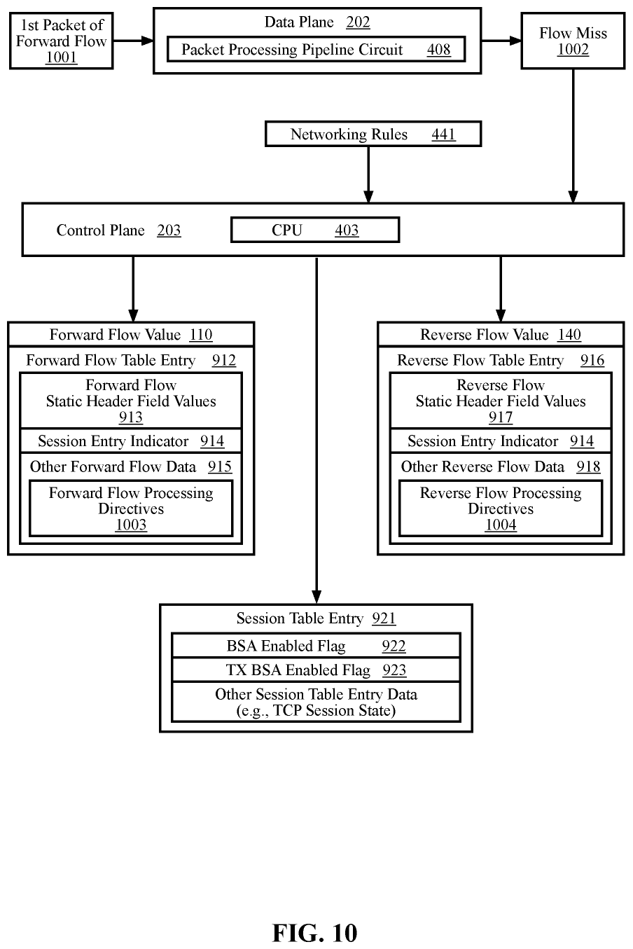

FIG. 10 is a high level conceptual diagram illustrating an example of a control plane 203 producing a forward flow table entry 912, a reverse flow table entry 916, and a session table entry 921, according to some aspects. The control plane may be implemented by a general purpose processor such as CPU 403 and the data plane may be implemented by a packet processing pipeline circuit 408. The first packet of a forward flow 1001 may be received by the data plane 202 of a tunnel endpoint. The data plane may not yet be configured to process the forward flow when the first packet of the forward flow 1001 is received. The data plane 202 may generate a flow miss 1002 in response to receiving a packet of an unknown flow. As such, the data plane may generate a flow miss 1002 in response to receiving the first packet of the forward flow 1001. The flow miss 1002 may be sent to the control plane 203 such that the control plane 203 may store a forward flow table entry 912 in the flow table to thereby configure the data plane to process packets in the forward flow. The control plane may receive the flow miss 1002, which may include the PHV of the first packet of the forward flow 1001. The control plane may use the networking rules 441 to generate forward flow processing directives 1003. The forward flow processing directives may include executable instructions for the packet processing pipeline circuit to execute when processing packets of the forward flow. The forward flow processing directives may include data for use by the executable instructions. For example, the control plane may determine that the forward flow packet may be encapsulated and sent to the remote tunnel endpoint. As such, the processing directives produced by the control plane for the forward flow may include a series of executable instructions for encapsulating the forward flow packet or an abbreviated forward flow packet in an encapsulating packet and for sending the encapsulating packet to the remote tunnel endpoint.

Also in response to receiving the flow miss, the control plane may store a reverse flow table entry 916 in the flow table to thereby configure the data plane to process packets in the reverse flow. The control plane may use the networking rules 441 to generate reverse flow processing directives 1004 that may include data and executable instructions that the data plane may use for processing packets in the reverse flow. The reverse flow processing directives 1004 may be included in the reverse flow table entry 916. The control plane may also store the session table entry 921 in the session table in response to receiving the flow miss 1002. The data plane may use the session table entry for tracking and updating the status of the session that includes the forward flow and the reverse flow.

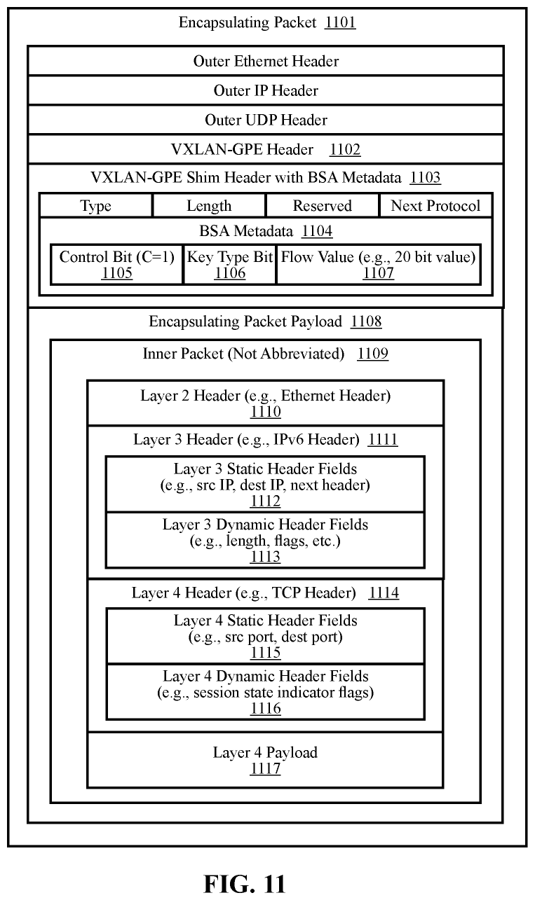

FIG. 11 is a high level conceptual diagram illustrating an example of an encapsulating packet 1101 that includes the static header fields and bandwidth saving aspect (BSA) metadata, according to some aspects. The encapsulating packet 1101 illustrated in FIG. 11 is an example of a VXLAN-GPE packet. As is known in the art and as is specified in the RFCs for VXLAN-GPE and GENEVE, an encapsulating packet 1101 may contain an outer ethernet header, an outer IP header, an outer UDP header, a VXLAN-GPE header 1102, and an encapsulating packet payload 1108. The encapsulating packet payload 1108 may include an inner packet 1109 such as a forward flow packet 101 or a reverse flow packet 131. The inner packet 1109 may include a layer 2 header 1110 (e.g., an ethernet header), a layer 3 header 1111 (e.g., an IPv6 header), a layer 4 header 1114 (e.g., a TCP header), and a layer 4 payload 1117. The layer 3 header 1111 may include layer 3 static header fields 1112 (e.g., source IP, destination IP, next header), and layer 3 dynamic header fields 1113 (e.g., length, flags, etc.). The layer 4 header 1114 may include layer 4 static header fields 1115 (e.g., source port, destination port), and layer 4 dynamic header fields 1116 (e.g., session state indicator flags).

The encapsulating packet 1101 may also contain a VXLAN-GPE shim header 1103 that contains BSA metadata 1104. The BSA metadata 1104 may include a control bit 1105, a key type bit 1106, and a flow value 1107. The control bit may indicate whether the static header fields are omitted such that the encapsulated packet is an abbreviated packet or whether the static header fields are included such that the encapsulated packet is not an abbreviated packet. For example, a control bit value C=0 may indicate an abbreviated packet and a control bit value C=1 may indicate an entire packet. The flow value 1107 may be a reverse flow value or a forward flow value. A networking device may have a flow table for IPv4 addresses and a flow table for IPv6 addresses. The key type bit may indicate whether the flow value is for an IPv4 flow (e.g., key type bit=0 indicates IPv4) or is for an IPv6 flow (e.g., key type bit=1 indicates IPv6). The key type bit 1106 may thereby ensure that the flow value may be used to obtain a flow table entry from the correct table.

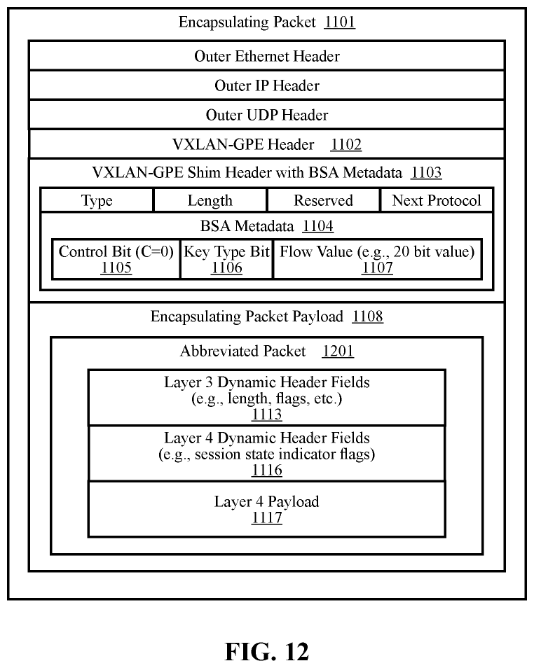

FIG. 12 is a high level conceptual diagram illustrating an example of an encapsulating packet 1101 that omits the static header fields and has bandwidth saving aspect (BSA) metadata 1104 in a VXLAN-GPE shim header 1103, according to some aspects. The encapsulating packet 1101 illustrated in FIG. 12 is an example of a VXLAN-GPE packet that omits the static header fields that are included in the encapsulating packet illustrated in FIG. 11. The BSA metadata 1104 illustrated in FIG. 12 has a control bit 1105 that may be set to C=0 to indicate that the static header fields are omitted. The encapsulating packet payload may therefore be an abbreviated packet 1201 that includes the layer 3 dynamic header fields 1113, the layer 4 dynamic header fields, and the layer 4 payload 1117. The layer 2 header, layer 3 static header fields 1112, and the layer 4 static header fields 1115 are omitted from the abbreviated packet 1201. The VXLAN-GPE standards document currently provides that next protocol values in the range of 0x80-0xFD may be used for custom shim headers. As such, a next protocol value within that range may indicate a shim header that includes BSA metadata.

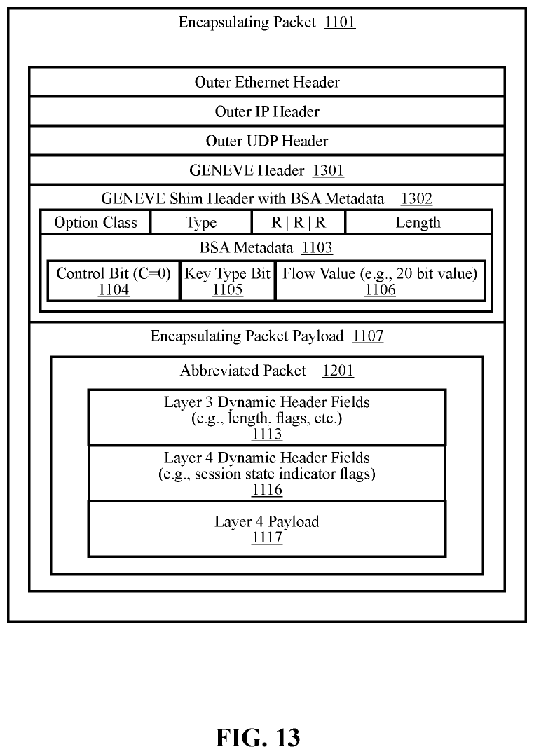

FIG. 13 is a high level conceptual diagram illustrating an example of an encapsulating packet 1101 that is a GENEVE packet omitting the static header fields and having BSA metadata 1104 in a GENEVE shim header 1302, according to some aspects. The encapsulating packet may have a GENEVE header 1301 and a GENEVE shim header 1302 as is known in the art. GENEVE shim headers are used for extending the GENEVE protocol. Here, the GENEVE shim header 1302 includes BSA metadata that includes a control bit 1105 set to C=0 to indicate that the encapsulated packet may be an abbreviated packet 1201 such as the abbreviated packet 1201 illustrated in FIG. 12. The current GENEVE standards document supports adding custom GENEVE options using Type Length Value format, as is shown in FIG. 13.

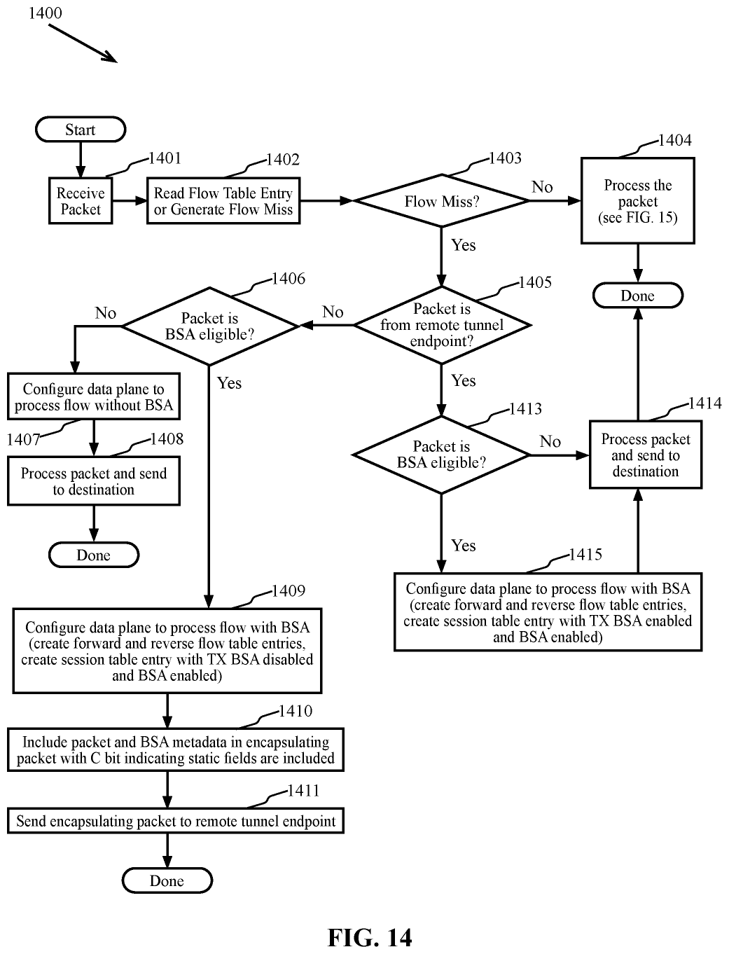

FIG. 14 is a high level flow diagram illustrating an example of a process for handling a flow miss 1400, according to some aspects. The process illustrated in FIG. 14 may be performed by the data plane and the control plane. After the start, a packet may be received at block 1401. At block 1402, the flow value for the packet may be calculated and used to query the flow table. A flow miss may occur if there is no flow table entry for the packet at block 1402. At decision block 1403 the flow miss may be detected. The process may move to block 1404 if no flow miss is detected and otherwise may move to decision block 1405. At block 1404, the packet may be processed before the process may be done. Processing the packet at blocks 1402-1404 may be performed by the data plane. The control plane may perform the processing indicated by blocks 1405-1415. The process may move to decision block 1413 if the packet is from a remote tunnel endpoint at decision block 1405 and may otherwise move to decision block 1406. The process may move to block 1409 if the packet is BSA eligible at decision block 1406 and may otherwise move to block 1407. At block 1407, the control plane may configure the data plane to process the flow without BSA. At block 1408 the packet may be processed and sent to its destination (e.g., encapsulated without BSA metadata and sent to the remote tunnel endpoint) before the process may be done. At block 1409, the control plane may configure the data plane to process the flow with BSA by, for example, creating a forward flow table entry, a reverse flow table entry, and a session table entry with the BSA enabled flag indicating that BSA is enabled for the session (e.g., BSA enabled=true) and the TX BSA enabled flag indicating that encapsulating abbreviated packets is disabled for the session (e.g., TX BSA enabled=false). At block 1410 the packet may be encapsulated in an encapsulating packet that includes BSA metadata. The BSA metadata indicates that the static header fields are included in the encapsulated packet. At block 1411, the encapsulating packet may be sent to the remote tunnel endpoint. The process may move to block 1415 if the packet is BSA eligible at decision block 1413 and may otherwise move to block 1414. At block 1414, the packet may be processed and sent to its destination before the process may be done. At block 1415, the control plane may configure the data plane to process the flow with BSA by, for example, creating a forward flow table entry, a reverse flow table entry, and a session table entry with the BSA enabled flag indicating that BSA is enabled for the session (e.g., BSA enabled=true) and the TX BSA enabled flag indicating that encapsulating abbreviated packets is enabled for the session (e.g., TX BSA enabled=true).

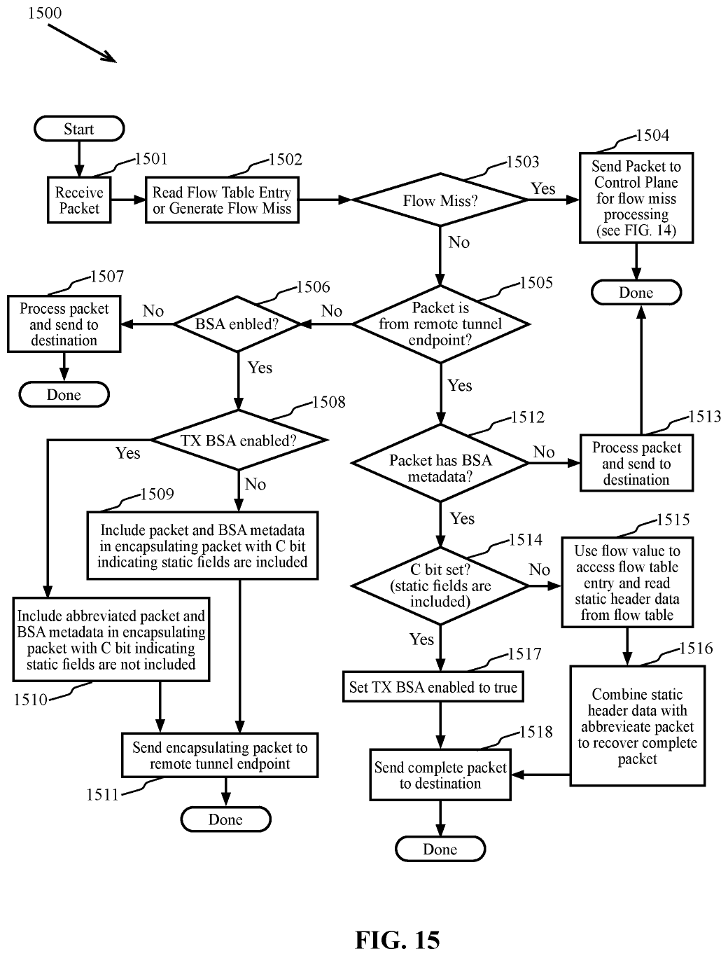

FIG. 15 is a high level flow diagram illustrating an example of a process for handling packets for BSA enabled flows 1500, according to some aspects. The process illustrated in FIG. may be performed entirely within the data plane. After the start, a packet may be received at block 1501. At block 1502, the flow value for the packet may be calculated and used to query the flow table. A flow miss occurs if no flow table entry is found for the packet at block 1502. The process may move to block 1504 if a flow miss is detected at decision block 1503 and otherwise may move to decision block 1505. At block 1504, the packet may be passed to the control plane before processing in the data plane is done. The process may move to decision block 1512 if the packet is from the remote tunnel endpoint at decision block 1505 and otherwise may move to decision block 1506. The process may move to block 1507 if BSA is enabled at decision block 1506 and otherwise may move to decision block 1508. At block 1507, the packet may be processed and sent to its destination. The process may move to block 1510 if TX BSA is enabled at decision block 1508 and otherwise moves to block 1509. At block 1509, the packet and BSA metadata may be included in an encapsulating packet with the control bit indicating static fields are included. At block 1510, an abbreviated packet and BSA metadata may be included in an encapsulating packet with the control bit indicating static fields are not included. At block 1511, the encapsulating packet may be sent to the remote tunnel endpoint.

If the packet is from the remote tunnel endpoint at decision block 1505, then the packet may be an encapsulating packet that encapsulates a complete packet (e.g., forward flow packet 101 or reverse flow packet 131) or an abbreviated packet (e.g., abbreviated packet 1201). For example, if the encapsulating packet has BSA metadata with the control bit set, then a complete packet may be encapsulated and otherwise an abbreviated packet may be encapsulated. The process may move to block 1514 if the packet includes BSA metadata at decision block 1512 and may otherwise move to decision block 1513. At block 1513, the packet may be processed and sent to its destination. The process may move to block 1517 if the control bit in the BSA metadata indicates that the static header fields are included in the encapsulated packet (a complete packet may be encapsulated) at decision block 1514 and may otherwise move to block 1515 (an abbreviated packet may be encapsulated). At block 1515, the flow value in the BSA metadata may be used to access the flow table entry for the packet and the static header fields for the packet may be read from the flow table entry. At block 1516, the static header fields obtained from the flow table may be combined with the abbreviated packet to recover the complete packet. FIG. 15 illustrates the process moving from block 1516 to block 1518. In some implementations, the process moves from block 1516 to block 1517. At block 1517, the TX BSA flag may be set to indicate that the tunnel endpoint may omit the static header fields from the encapsulated packets that are sent to the other tunnel endpoint for the flows in the session. At block 1518, the complete packet may be sent to its destination.

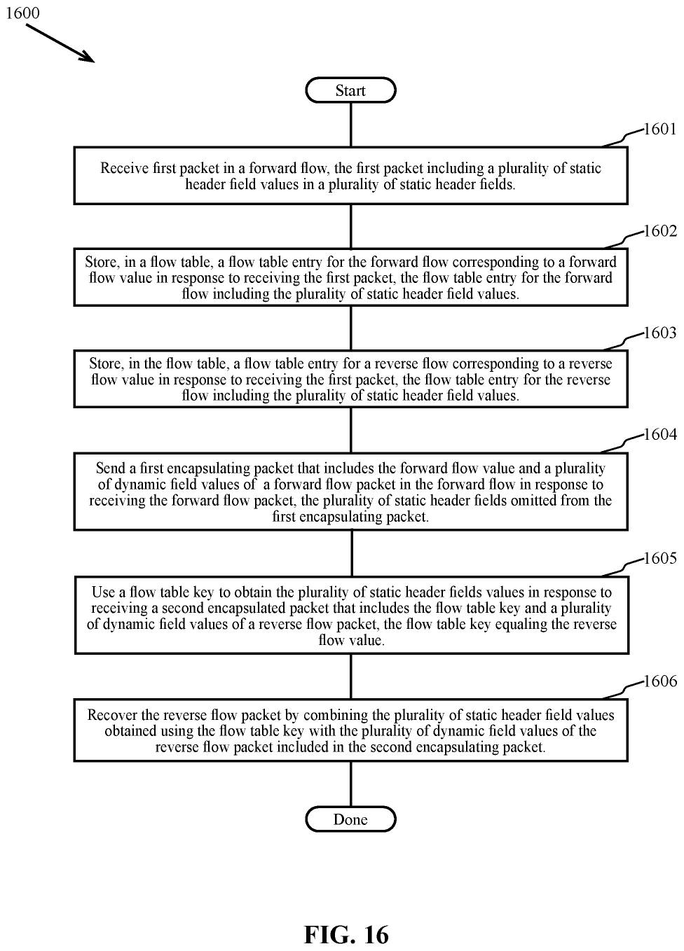

FIG. 16 is a high level flow diagram illustrating an example of a method 1600 for using abbreviated packets that omit header fields, according to some aspects. At block 1601, a first packet in a forward flow may be received, the first packet including a plurality of static header field values in a plurality of static header fields. At block 1602, a flow table entry for the forward flow may be stored in a flow table corresponding to a forward flow value in response to receiving the first packet, the flow table entry for the forward flow including the plurality of static header field values. At block 1603, a flow table entry for a reverse flow may be stored in the flow table corresponding to a reverse flow value in response to receiving the first packet, the flow table entry for the reverse flow including the plurality of static header field values. At block 1604, a first encapsulating packet that includes the forward flow value and a plurality of dynamic field values of a forward flow packet in the forward flow may be sent in response to receiving the forward flow packet, the plurality of static header fields omitted from the first encapsulating packet. At block 1605, a flow table key may be used to obtain the plurality of static header fields values in response to receiving a second encapsulated packet that includes the flow table key and a plurality of dynamic field values of a reverse flow packet, the flow table key equaling the reverse flow value. At block 1606, the reverse flow packet may be recovered by combining the plurality of static header field values obtained using the flow table key with the plurality of dynamic field values of the reverse flow packet included in the second encapsulating packet.

Aspects described above may be ultimately implemented in a networking device that includes physical circuits that implement digital data processing, storage, and communications. The networking device may include processing circuits, read only memory (ROM), random access memory (RAM), ternary content-addressable memory (TCAM), and at least one interface (interface(s)). The CPU cores described above may be implemented in processing circuits and memory that may be integrated into the same integrated circuit (IC) device as ASIC circuits and memory that are used to implement the programmable packet processing pipeline. For example, the CPU and other semiconductor chip circuits are fabricated on the same semiconductor substrate to form a System-on-Chip (SoC). The networking device may be implemented as a single IC device (e.g., fabricated on a single substrate) or the networking device may be implemented as a system that includes multiple IC devices connected by, for example, a printed circuit board (PCB). The interfaces may include network interfaces (e.g., Ethernet interfaces and/or InfiniBand interfaces) and/or PCIe interfaces. The interfaces may also include other management and control interfaces such as inter-integrated circuit (I2C), general purpose input/outputs (IOs), universal serial bus (USB), universal asynchronous receiver/transmitter (UART), serial peripheral interface (SPI), and embedded multimedia card (eMMC).

Although the operations of the method(s) herein are shown and described in a particular order, the order of the operations of each method may be altered so that certain operations may be performed in an inverse order or so that certain operations may be performed, at least in part, concurrently with other operations. Instructions or sub-operations of distinct operations may be implemented in an intermittent and/or alternating manner.

It may also be noted that at least some of the operations for the methods described herein may be implemented using software instructions stored on a computer usable storage medium for execution by a computer. For example, a computer program product may include a computer usable storage medium to store a computer readable program.

The computer-usable or computer-readable storage medium may be an electronic, magnetic, optical, electromagnetic, infrared, or semiconductor system (or apparatus or device). Examples of non-transitory computer-usable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Although specific examples have been described and illustrated, the scope of the claimed systems, methods, devices, etc. is not to be limited to the specific forms or arrangements of parts so described and illustrated. The scope may be defined by the claims appended hereto and their equivalents.

What is claimed is:

1. A system comprising:
a packet processing pipeline circuit configured to implement a data plane; and
a processor configured to implement a control plane,
wherein the control plane and the data plane are configured to:
send a first encapsulating packet that includes a forward flow packet of a forward flow and a forward flow value associated with the forward flow, the forward flow packet including a plurality of static header fields of the forward flow packet and a plurality of dynamic fields of the forward flow packet; and
send a second encapsulating packet, the second encapsulating packet including the forward flow value and a plurality of dynamic fields of a second forward flow packet of the forward flow, wherein a plurality of static header fields of the second forward flow packet is omitted from the second encapsulating packet.

2. The system of claim 1, wherein the plurality of static header fields includes a destination address field, a source address field, a destination port field, and a source port field.

3. The system of claim 1, wherein the control plane and the data plane are configured to:
store a reverse flow value corresponding to a plurality of static header field values of the forward flow packet;
receive a third encapsulating packet that includes the reverse flow value and a plurality of dynamic header field values of a reverse flow packet; and
use the dynamic header field values of the reverse flow packet and the reverse flow value to recover the reverse flow packet,
wherein the plurality of static header fields of the reverse flow packet is omitted from the third encapsulating packet.

4. The system of claim 3, wherein recovering the reverse flow packet includes:
using the reverse flow value to obtain the plurality of static header field values from a flow table; and
using the plurality of static header field values to assemble a header of the reverse flow packet in response to obtaining the plurality of static header field values from the flow table.

5. The system of claim 3, further including:
a memory configured to store a flow table that includes a flow table entry for the forward flow and that includes a flow table entry for a reverse flow that includes the reverse flow packet,
wherein:
the data plane is configured to produce the reverse flow packet by using the reverse flow value that is in the third encapsulating packet to locate the flow table entry for the reverse flow and to read the plurality of static header field values of the reverse flow packet from the flow table entry for the reverse flow; and
the data plane is configured to use forward flow value to locate the flow table entry for the forward flow in response to receiving a packet of the forward flow.

6. The system of claim 5, wherein the control plane is configured to store the flow table entry for the forward flow and the flow table entry for the reverse flow in the flow table in response to receiving the forward flow packet.

7. The system of claim 5, wherein the control plane is configured to:
use a plurality of networking rules to produce forward flow processing directives and to store the forward flow processing directives in the flow table entry for the forward flow; and
use the plurality of networking rules to produce reverse flow processing directives and to store the reverse flow processing directives in the flow table entry for the reverse flow.

8. The system of claim 3, wherein hashing a 5-tuple of the reverse flow packet produces the reverse flow value.

9. The system of claim 3, wherein:
the plurality of static header field values of the forward flow packet includes a forward flow destination address value, a forward flow source address value, a forward flow destination port value, and a forward flow source port value; and
the plurality of static header field values of the reverse flow packet includes a reverse flow destination address value that equals the forward flow source address value, a reverse flow source address value that equals the forward flow destination address value, a reverse flow destination port value that equals the forward flow source port value, and a reverse flow source port value that equals the forward flow destination port value.

10. The system of claim 1, wherein hashing a 5-tuple of the forward flow packet produces the forward flow value.

11. The system of claim 1, further including:
a networking device configured to:
store a plurality of static header field values of the forward flow packet corresponding to the forward flow value in response to receiving the first encapsulating packet;
use the forward flow value in the second encapsulated packet to obtain the plurality of static header field values of the forward flow packet in response to receiving the second encapsulating packet; and
recover the second forward flow packet by combining the plurality of static header field values obtained using the forward flow value with the dynamic fields of the second forward flow packet that are in the second encapsulating packet.

12. The system of claim 1, wherein the first encapsulating packet includes a shim header that includes the forward flow value.

13. The system of claim 1, wherein the first encapsulating packet is a virtual extensible local area network (VXLAN) packet.

14. The system of claim 1, wherein the first encapsulating packet is a GENEVE packet.

15. The system of claim 1, wherein omitting the plurality of static header fields from encapsulating packets includes:
storing, in a flow table, a first value corresponding to a plurality of static header field values of a first packet in response to receiving a third encapsulating packet that includes the first value and the first packet;
receiving a fourth encapsulating packet that includes the first value and a plurality of dynamic field values of a second packet;
using the first value in the fourth encapsulated packet to obtain the plurality of static header field values of the first packet from the flow table; and
recovering the second packet by combining the plurality of static header field values obtained using the first value with the plurality of dynamic field values of the second packet included in the fourth encapsulating packet.

16. A system comprising:
a packet processing pipeline circuit configured to implement a data plane; and
a processor configured to implement a control plane,
wherein the control plane and the data plane are configured to omit a plurality of static header fields from a plurality of encapsulating packets by:
storing a plurality of static header field values of a forward flow packet corresponding to a forward flow value in response to receiving a first encapsulating packet that includes the forward flow value and the forward flow packet; and
recovering a second forward flow packet by combining the plurality of static header field values stored corresponding to the forward flow value with a plurality of dynamic field values of the second forward flow packet in response to receiving a second encapsulating packet that includes the forward flow value and the plurality of dynamic field values of the second forward flow packet,
wherein the plurality of static header fields of the second forward flow packet is omitted from the second encapsulating packet.

17. The system of claim 16, wherein omitting the plurality of static header fields from the plurality of encapsulating packets includes:
storing a flow table entry for a reverse flow corresponding to a reverse flow value in response to receiving the first encapsulating packet;
calculating a flow table key for a reverse flow packet that is in the reverse flow in response to receiving the reverse flow packet, the flow table key equaling the reverse flow value;
determining that the reverse flow omits the plurality of static header fields by using the flow table key to access the flow table entry for the reverse flow; and
producing a third encapsulating packet that includes the reverse flow value and a plurality of dynamic fields of the reverse flow packet in response to determining that the reverse flow omits the plurality of static header fields,
wherein the third encapsulating packet omits the plurality of static header fields.

18. The system of claim 17, further including:
a memory configured to store a flow table that includes a flow table entry for a forward flow that includes the forward flow packet and that includes the flow table entry for the reverse flow,
wherein:
the data plane is configured to recover the second forward flow packet by using the forward flow value that is in the second encapsulating packet to locate the flow table entry for the forward flow and to read the plurality of static header field values of the forward flow packet from the flow table entry for the forward flow; and
the data plane is configured to use the reverse flow value to locate the flow table entry for the reverse flow in response to receiving a packet of the reverse flow.

19. A method comprising:
receiving a first packet in a forward flow, the first packet including a plurality of static header field values in a plurality of static header fields;
storing, in a flow table, a flow table entry for the forward flow corresponding to a forward flow value in response to receiving the first packet, the flow table entry for the forward flow including the plurality of static header field values; and
sending a first encapsulating packet that includes the forward flow value and a plurality of dynamic field values of a forward flow packet in the forward flow in response to receiving the forward flow packet, the plurality of static header fields omitted from the first encapsulating packet.

20. The method of claim 19, further including:
storing, in the flow table, a flow table entry for a reverse flow corresponding to a reverse flow value in response to receiving the first packet, the flow table entry for the reverse flow including the plurality of static header field values;
using a flow table key to obtain the plurality of static header fields values in response to receiving a second encapsulated packet that includes the flow table key and a plurality of dynamic field values of a reverse flow packet, the flow table key equaling the reverse flow value; and
recovering the reverse flow packet by combining the plurality of static header field values obtained using the flow table key with the plurality of dynamic field values of the reverse flow packet included in the second encapsulating packet.
